(19) United States
(12) Patent Application Publication
(10) Pub. No.: US 2026/0172889 A1
(43) Pub. Date: Jun. 18, 2026

(54) SL CONFIGURATION ASSISTANCE METHOD, FIRST TERMINAL, AND NETWORK SIDE DEVICE

(71) Applicant: VIVO MOBILE COMMUNICATION CO., LTD., Dongguan (CN)

(72) Inventors: Qian ZHENG, Dongguan (CN); Xiao XIAO, Dongguan (CN)

(73) Assignee: VIVO MOBILE COMMUNICATION CO., LTD., Dongguan (CN)

(21) Appl. No.: 19/464,593

(22) Filed: Jan. 29, 2026

Related U.S. Application Data
(63) Continuation of application No. PCT/CN2024/108925, filed on Jul. 31, 2024.

(30) Foreign Application Priority Data
Aug. 1, 2023 (CN) 202310960145.5

(51) Int. Cl. H04W 28/02; H04W 28/24; H04W 76/19; H04W 76/20; H04W 92/18

(52) U.S. Cl. CPC H04W 28/0268; H04W 28/24; H04W 76/19; H04W 76/20; H04W 92/18

(57) ABSTRACT

An Sidelink (SL) configuration assistance method, a first terminal, and a network side device are provided. The sidelink SL configuration assistance method includes: sending, by a first terminal, SL assistance information to a network side device. The SL assistance information represents a mapping relationship between at least one PC5 Quality Of Service (QoS) flow and at least one SL frequency, and the SL assistance information is used to assist in SL-Radio Bearer (RB) configuration.

### CROSS-REFERENCE TO RELATED APPLICATIONS

This application is a continuation of International Application No. PCT/CN 2024/108925, filed on Jul. 31, 2024, which claims priority to Chinese Patent Application No. 202310960145.5, filed in China on Aug. 1, 2023. The entire contents of each of the above-referenced applications are expressly incorporated herein by reference.

### TECHNICAL FIELD

This application pertains to the field of communication technologies, and specifically relates to a Sidelink (SL) configuration assistance method, a first terminal, and a network side device.

### BACKGROUND

In a Long Term Evolution (LTE) SL Carrier Aggregation (CA) framework, an upper layer of a terminal determines a mapping relationship between a service and a frequency, and provides an Access Stratum (AS) with a mapping between a Destination Layer-2 Identity (ID) and an SL frequency.

In a New Radio (NR) SL CA scenario, if the LTE SL CA framework is used to perform SL radio bearer configuration, it may be difficult for the terminal to work based on a frequency specified by the upper layer, and therefore the LTE SL CA framework cannot be reused.

### SUMMARY

Embodiments of this application provide an SL configuration assistance method, a first terminal, and a network side device, to assist in accurate configuration of an SL radio bearer in an NR SL CA scenario.

According to a first aspect, a sidelink SL configuration assistance method is provided. The method is executed by a first terminal and the method includes:
sending, by a first terminal, SL assistance information to a network side device, where the SL assistance information represents a mapping relationship between at least one PC5 Quality of Service (QoS) flow and at least one SL frequency, and the SL assistance information is used to assist in SL-Radio Bearer (RB) configuration.

According to a second aspect, a sidelink SL configuration assistance method is provided. The method is executed by a network side device and the method includes:
receiving, by a network side device, SL assistance information from a first terminal, where the SL assistance information represents a mapping relationship between at least one PC5 QoS flow and at least one SL frequency; and
sending, by the network side device, first radio bearer configuration information to the first terminal, where the first radio bearer configuration information includes a mapping relationship between at least one SL-RB and at least one PC5 QoS flow, and SL frequencies of PC5 QoS flows associated with each SL-RB configuration are the same.

According to a third aspect, a sidelink SL configuration assistance method is further provided. The method is executed by a first terminal and the method includes:
obtaining, by a first terminal, second radio bearer configuration information, where the second radio bearer configuration information includes a mapping relationship between at least one SL-RB and at least one PC5 QoS flow; and
performing, by the first terminal, an SL-RB configuration operation on a to-be-transmitted target QoS flow based on the second radio bearer configuration information and a mapping relationship between at least one PC5 QoS flow and at least one SL frequency.

According to a fourth aspect, an SL configuration assistance apparatus is provided. The apparatus includes:
a first sending module, configured to send SL assistance information to a network side device, where the SL assistance information represents a mapping relationship between at least one PC5 QoS flow and at least one SL frequency, and the SL assistance information is used to assist in SL-RB configuration.

According to a fifth aspect, a sidelink SL configuration assistance apparatus is provided. The apparatus includes:
a receiving module, configured to receive SL assistance information from a first terminal, where the SL assistance information represents a mapping relationship between at least one PC5 QoS flow and at least one SL frequency; and
a second sending module, configured to send first radio bearer configuration information to the first terminal, where the first radio bearer configuration information includes a mapping relationship between at least one SL-RB and at least one PC5 QoS flow, and SL frequencies of PC5 QoS flows associated with each SL-RB configuration are the same.

According to a sixth aspect, an SL configuration assistance apparatus is provided. The apparatus includes:
an obtaining module, configured to obtain second radio bearer configuration information, where the second radio bearer configuration information includes a mapping relationship between at least one SL-RB and at least one PC5 quality of service flow QoS flow; and
a first processing module, configured to perform an SL-RB configuration operation on a to-be-transmitted target QoS flow based on the second radio bearer configuration information and a mapping relationship between at least one PC5 QoS flow and at least one SL frequency.

According to a seventh aspect, a first terminal is provided. The first terminal includes a processor and a memory, the memory stores a program or an instruction that can be run on the processor, and the program or the instruction is executed by the processor to implement the steps of the method according to the first aspect or the steps of the method according to the third aspect.

According to an eighth aspect, a first terminal is provided, including a processor and a communication interface. The communication interface is configured to send SL assistance information to a network side device, where the SL assistance information represents a mapping relationship between at least one PC5 QoS flow and at least one SL frequency, and the SL assistance information is used to assist in SL-RB configuration; or
the processor is configured to obtain second radio bearer configuration information, where the second radio bearer configuration information includes a mapping relationship between at least one SL-RB and at least one PC5 QoS flow; and the communication interface is configured to perform an SL-RB configuration operation on a to-be-transmitted target QoS flow based on the second radio bearer configuration information and a mapping relationship between at least one PC5 QoS flow and at least one SL frequency.

According to a ninth aspect, a network side device is provided. The network side device includes a processor and a memory, the memory stores a program or an instruction that can be run on the processor, and the program or the instruction is executed by the processor to implement the steps of the method according to the second aspect.

According to a tenth aspect, a network side device is provided, including a processor and a communication interface. The communication interface is configured to: receive SL assistance information from a first terminal, where the SL assistance information represents a mapping relationship between at least one PC5 QoS flow and at least one SL frequency; and send first radio bearer configuration information to the first terminal, where the first radio bearer configuration information includes a mapping relationship between at least one SL-RB and at least one PC5 QoS flow, and SL frequencies of PC5 QoS flows associated with each SL-RB configuration are the same.

According to an eleventh aspect, a readable storage medium is provided. The readable storage medium stores a program or an instruction, and the program or the instruction is executed by a processor to implement the steps of the method according to the first aspect, or the steps of the method according to the second aspect, or the steps of the method according to the third aspect.

According to a twelfth aspect, a wireless communication system is provided, including a first terminal and a network side device. The first terminal may be configured to execute the steps of the method according to the first aspect or the steps of the method according to the third aspect, and the network side device may be configured to execute the steps of the method according to the second aspect.

According to a thirteenth aspect, a chip is provided. The chip includes a processor and a communication interface, the communication interface is coupled to the processor, and the processor is configured to run a program or an instruction to implement the method according to the first aspect, or the method according to the second aspect, or the method according to the third aspect.

According to a fourteenth aspect, a computer program/program product is provided. The computer program/program product is stored in a storage medium, and the program/program product is executed by at least one processor to implement the steps of the sidelink SL configuration assistance method according to the first aspect, or the steps of the sidelink SL configuration assistance method according to the second aspect, or the steps of the SL configuration assistance method according to the third aspect.

In the embodiments of this application, an SL configuration assistance method applicable to an NR SL CA scenario is provided. For example, a first terminal sends SL assistance information to a network side device, where the SL assistance information represents a mapping relationship between at least one PC5 QoS flow and at least one SL frequency. Therefore, the network side device may assist in SL-RB configuration by using the mapping relationship represented by the SL assistance information, thereby adapting to a granularity of a PC5 QoS flow level of an NR SL. That is, a frequency mapping method at a PC5 QoS flow level is proposed, so that after SL-RB configuration is performed by using the mapping relationship, the first terminal can work based on a frequency specified by an upper layer protocol of the terminal to implement accurate configuration of an SL radio bearer in the NR SL CA scenario.

### BRIEF DESCRIPTION OF DRAWINGS

FIG. 1 is a block diagram of a wireless communication system to which the embodiments of this application can be applied;

FIG. 2 is an example block diagram of an SL in a related technology;

FIG. 3 is a schematic diagram of inter-layer interaction between an upper layer and an access stratum that are of UE in a related technology;

FIG. 4 is a signalling interaction diagram of NR SL unicast communication between UE 1 in an RRC connected state and UE 2 in a related technology;

FIG. 5 is a signalling interaction diagram of NR SL groupcast and/or broadcast communication between UE 1 in an RRC connected state and UE 2 in a related technology;

FIG. 6 is a signalling interaction diagram of NR SL unicast communication between UE 1 in an RRC inactive state or an idle state and UE 2 in a related technology;

FIG. 7 is a signalling interaction diagram of NR SL groupcast and/or broadcast communication between UE 1 in an RRC inactive state or an idle state and UE 2 in a related technology;

FIG. 8 is a signalling interaction diagram of NR SL unicast communication between UE 1 in an OOC state and UE 2 in a related technology;

FIG. 9 is a signalling interaction diagram of NR SL groupcast and/or broadcast communication between UE 1 in an OOC state and UE 2 in a related technology;

FIG. 10 is a first schematic flowchart of an SL configuration assistance method according to an embodiment of this application;

FIG. 11 is a second schematic flowchart of an SL configuration assistance method according to an embodiment of this application;

FIG. 12 is a third schematic flowchart of an SL configuration assistance method according to an embodiment of this application;

FIG. 13 is a signalling interaction diagram of an SL configuration assistance method according to an embodiment of this application;

FIG. 14 is a first schematic structural diagram of an SL configuration assistance apparatus according to an embodiment of this application;

FIG. 15 is a second schematic structural diagram of an SL configuration assistance apparatus according to an embodiment of this application;

FIG. 16 is a third schematic structural diagram of an SL configuration assistance apparatus according to an embodiment of this application;

FIG. 17 is a schematic structural diagram of a communication device according to an embodiment of this application;

FIG. 18 is a schematic structural diagram of hardware of a first terminal according to an embodiment of this application; and

FIG. 19 is a schematic structural diagram of a network side device according to an embodiment of this application.

### DETAILED DESCRIPTION

The following clearly describes the technical solutions in the embodiments of this application with reference to the accompanying drawings in the embodiments of this application. Apparently, the described embodiments are some but not all of the embodiments of this application. All other embodiments obtained by a person of ordinary skill based on the embodiments of this application shall fall within the protection scope of this application.

In this application, the terms “first”, “second”, and the like are intended to distinguish between similar objects but do not describe a specific order or sequence. It should be understood that the terms used in such a way are interchangeable in proper circumstances so that the embodiments of this application can be implemented in orders other than the order illustrated or described herein. Objects classified by “first” and “second” are usually of a same type, and the number of objects is not limited. For example, there may be one or more first objects. In addition, “or” in this application means at least one of connected objects. For example, “A or B” covers three schemes. Scheme 1: including A but excluding B; Scheme 2: including B but excluding A; Scheme 3: including both A and B. The character “/” generally indicates an “or” relationship between the associated objects.

The term “indication” in this application may be either a direct indication (or an explicit indication) or an indirect indication (or an implicit indication). A direct indication may be understood as that a sender explicitly informs a recipient of content such as specific information, an operation to be performed, or a requested result in a sent indication. An indirect indication may be understood as that a recipient determines corresponding information based on an indication sent by a sender, or makes a judgment and determines an operation to be performed or a requested result based on a judgment result.

It should be noted that technologies described in the embodiments of this application are not limited to an LTE/LTE-Advanced (LTE-A) system, and may further be applied to other wireless communication systems such as Code Division Multiple Access (CDMA), Time Division Multiple Access (TDMA), Frequency Division Multiple Access (FDMA), Orthogonal Frequency Division Multiple Access (OFDMA), Single-Carrier Frequency Division Multiple Access (SC-FDMA), or other systems. The terms “system” and “network” in the embodiments of this application may be used interchangeably. The technologies described can be applied to both the systems and the radio technologies mentioned above as well as to other systems and radio technologies. The following describes a New Radio (NR) system for example purposes, and NR terms are used in most of the following descriptions. These technologies can also be applied to systems other than the NR system, such as a 6th Generation (6G) communication system.

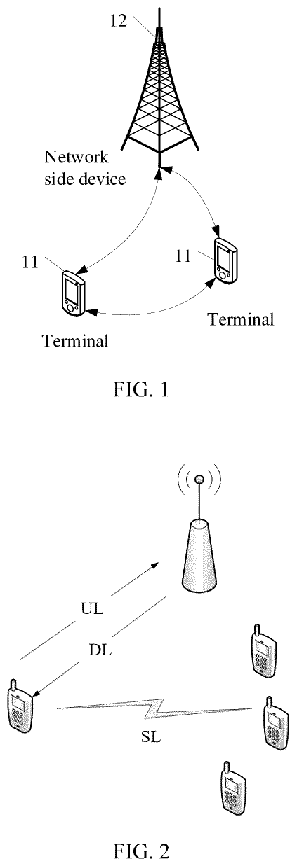

FIG. 1 is a block diagram of a wireless communication system to which the embodiments of this application can be applied. As shown in FIG. 1, the wireless communication system includes a terminal 11 and a network side device 12. The terminal 11 may be a terminal side device such as a mobile phone, a tablet personal computer, a laptop computer, a notebook computer, a Personal Digital Assistant (PDA), a palmtop computer, a netbook, an Ultra-mobile Personal Computer (UMPC), a Mobile Internet Device (MID), an Augmented Reality (AR) device, a Virtual Reality (VR) device, a robot, a wearable device, a flight vehicle, Vehicle User Equipment (VUE), shipborne equipment, Pedestrian User Equipment (PUE), a smart home (a home device with a wireless communication function, such as a refrigerator, a television, a washing machine, or a furniture), a game console, a Personal Computer (PC), a teller machine, or a self-service machine. The wearable device includes a smart watch, a smart band, a smart headset, smart glasses, smart jewelry (a smart bangle, a smart bracelet, a smart ring, a smart necklace, a smart anklet, and a smart chain), a smart wrist strap, a smart dress, and the like. The vehicle user equipment may also be referred to as an in-vehicle terminal, an in-vehicle controller, an in-vehicle module, an in-vehicle component, an in-vehicle chip, or an in-vehicle unit. It should be noted that a specific type of the terminal 11 is not limited in the embodiments of this application. The network side device 12 may include an access network device or a core network device. The access network device may also be referred to as a Radio Access Network (RAN) device, a radio access network function, or a radio access network unit. The access network device may include a base station, a Wireless Local Area Network (WLAN) Access Point (AP), a Wireless Fidelity (WiFi) node, or the like. The base station may be referred to as a NodeB (NB), an Evolved NodeB (eNB), a next generation NodeB (gNB), a New Radio NodeB (NR NodeB), an access point, a Relay Base Station (RBS), a Serving Base Station (SBS), a Base Transceiver Station (BTS), a radio base station, a radio transceiver, a Basic Service Set (BSS), an Extended Service Set (ESS), a home NodeB (HNB), a home evolved NodeB, a Transmission Reception Point (TRP), or another appropriate term in the field. As long as a same technical effect is achieved, the base station is not limited to a specified technical term. It should be noted that, in this application, only a base station in an NR system is used as an example, and a specific type of the base station is not limited.

The core network device may include but is not limited to at least one of the following: a core network node, a core network function, a Mobility Management Entity (MME), an Access and Mobility Management Function (AMF), a Session Management Function (SMF), a User Plane Function (UPF), a Policy Control Function (PCF), a Policy and Charging Rules Function (PCRF), an Edge Application Server Discovery Function (EASDF), Unified Data Management (UDM), a Unified Data Repository (UDR), a Home Subscriber Server (HSS), a Centralized Network Configuration (CNC), a Network Repository Function (NRF), a Network Exposure Function (NEF), a Local NEF (L-NEF), a Binding Support Function (BSF), an Application Function (AF), and the like. It should be noted that, in the embodiments of this application, only a core network device in an NR system is used as an example for description, and a specific type of the core network device is not limited.

To facilitate a clearer understanding of the technical solutions provided in the embodiments of this application, the following first describes some related background knowledge.

### 1. Introduction to the SL

An LTE system starts to support an SL (or a side link, an edge link, or the like) from Release 12, enabling direct data transmission between User Equipment (UE) without a network device.

FIG. 2 is an example block diagram of an SL in a related technology. As shown in FIG. 2, examples of an Uplink (UL) and a Downlink (DL) are further included in the figure.

The design of the LTE SL is applicable to public safety matters, such as emergency communication at fire sites or disaster sites such as earthquakes, or Vehicle to everything (V2X) communication. The vehicle to everything communication includes various services, such as basic security-related communication, advanced (automatic) driving, platooning, and sensor extension. The LTE SL only supports broadcast communication, so it is mainly used for basic security-related communication. Other advanced V2X services with strict QoS requirements in terms of latency and reliability are supported by an NR SL.

A 5G NR system may also support an SL interface for direct communication between terminals, and SL communication includes three transmission manners:
(1) SL broadcast communication;
(2) SL groupcast communication; and
(3) SL unicast communication.

Unicast, as the name suggests, is one-to-one transmission. Groupcast is one-to-many transmission, and broadcast is also one-to-many transmission without the concept of UE belonging to the same group. Currently, SL unicast and groupcast communication support a Hybrid Automatic Repeat Request (HARQ) feedback mechanism at a physical layer.

### 2. SL CA and Carrier Selection/Reselection

In an LTE SL, an SL CA transmission mode is supported, and a basic carrier selection or reselection procedure is as follows:

For a V2X service, an upper layer of UE provides an access stratum of the UE with a mapping relationship between a service type and a carrier frequency (mapping between V2X service types and V2X frequencies). During SL air interface transmission, the access stratum of the UE needs to ensure that a corresponding service is sent on a corresponding carrier frequency.

If the UE works in a base station scheduling mode (Mode 1), a base station allocates SL resources based on an SL Buffer Status Report (BSR) of the UE and information reported by a Sidelink UE Information message, to ensure that a corresponding service is sent on a corresponding carrier frequency.

If the UE works in a UE autonomous mode (Mode 2), the access stratum of the UE performs a carrier selection or reselection procedure when a carrier selection or reselection trigger condition is met. For example, the following steps are included:

S3-1. UE performs a carrier selection or reselection procedure when determining that a carrier selection or reselection trigger condition is met.

S3-2. At least one allowed carrier frequency is determined per logical channel.

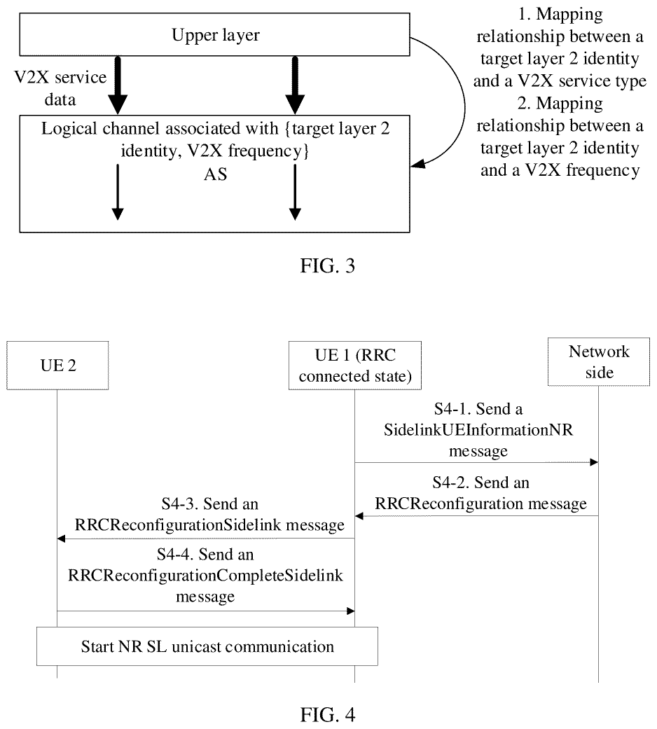

FIG. 3 is a schematic diagram of inter-layer interaction between an upper layer and an access stratum that are of UE in a related technology. As shown in FIG. 3, when service data (V2X service packets) arrives on at least one logical channel of the AS, at least one carrier frequency associated with each logical channel may be determined based on inter-layer interaction information.

S3-3. When each carrier frequency (hereinafter denoted as F1) in S3-1 is determined one by one and at least one carrier frequency is traversed, at least one candidate carrier(s) and/or at least one selected carrier(s) may be determined.

For example, there may be two cases: primary selection and reselection.

Case 1: Carrier primary selection evaluation: If there is no SL grant on F1, it is further determined that:

If a channel busy ratio (CBR) of F1 is less than a first CBR threshold, F1 is included in candidate carriers.

The first CBR threshold is determined by a first CBR-ProSe Per-Packet Priority (PPPP) mapping relationship configured by a network or preconfigured and a logical channel priority value corresponding to the logical channel.

The first CBR-PPPP mapping relationship is as follows:
priorityList-r15 SL-PriorityList-r13,
threshCBR-FreqReselection-r15 SL-CBR-r14 OPTIONAL, --Need OR.

Case 2: Carrier reselection evaluation: If there is an SL grant on F1, it is further determined that:
if a CBR of F1 is less than a second CBR threshold, F1 is continuously selected, that is, F1 is included in selected carriers; or
if a CBR of F1 is greater than or equal to a second CBR threshold, it is considered that F1 meets a carrier reselection condition, that is, F1 is included in candidate carriers.

The second CBR threshold is determined by a second CBR-PPPP mapping relationship configured by a network or preconfigured and a logical channel priority value corresponding to the logical channel.

The second CBR-PPPP mapping relationship is as follows:
priorityList-r15 SL-PriorityList-r13,
threshCBR-freqkeeping-r15 Sl-cbr-r14 Optional-- Need OR.

S3-4. Sort each carrier frequency of the at least one candidate carrier in S3-2 in ascending order based on a CBR value of each carrier frequency, and sequentially select a part of carrier frequencies of the at least one candidate carrier starting from a carrier frequency with a minimum CBR value. For example, a quantity of carrier frequencies to be selected is determined by a UE capability, and these selected candidate carriers are also included in selected carriers.

### 3. SL-Radio Bearer (SL-RB) Configuration

For example, Radio Resource Control (RRC) states of a transmit end UE are classified into three types.

Type 1: A transmit end (UE 1) is in an RRC connected state, and an SL-RB related configuration is sourced from a configuration of a dedicated message RRC reconfiguration (RRCReconfiguration) of a network side device.

Case 1a: UE 1 performs NR SL unicast communication with a receive end (UE 2).

FIG. 4 is a signalling interaction diagram of NR SL unicast communication between UE 1 in an RRC connected state and UE 2 in a related technology. As shown in FIG. 4, the following steps are included:

S4-0. UE 1 is in an RRC connected state, and the UE 1 performs NR SL unicast communication with UE 2.

S4-1. The UE 1 sends a SidelinkUEInformationNR message to a network, where the SidelinkUEInformationNR message includes a Destination Layer-2 ID, a communication type (cast type), a QoS parameter (QoS profile), and an SL frequency of the UE 2 in NR SL communication.

S4-2. The UE 1 receives an RRCReconfiguration message sent by the network, where the RRCReconfiguration message includes SL-RB related configurations classified into an SL-RB related configuration to be applied only to the UE 1 and an SL-RB related configuration to be applied to both the UE 1 and the UE 2.

The SL-RB related configuration to be applied only to the UE 1 takes effect directly on the UE 1.

S4-3. The UE 1 sends, to the UE 2 through an RRCReconfigurationSidelink message, the SL-RB related configuration that is included in the RRCReconfiguration message in S4-2 and to be applied to both the UE 1 and the UE 2.

S4-4. The UE 1 receives an RRCReconfigurationCompleteSidelink message fed back by the UE 2.

The SL-RB related configuration to be applied to both the UE 1 and the UE 2 takes effect after the RRCReconfigurationCompleteSidelink message is determined.

After S4-4, the UE 1 starts NR SL unicast communication with the UE 2.

Case 1b: UE 1 performs NR SL groupcast and/or broadcast communication with UE 2.

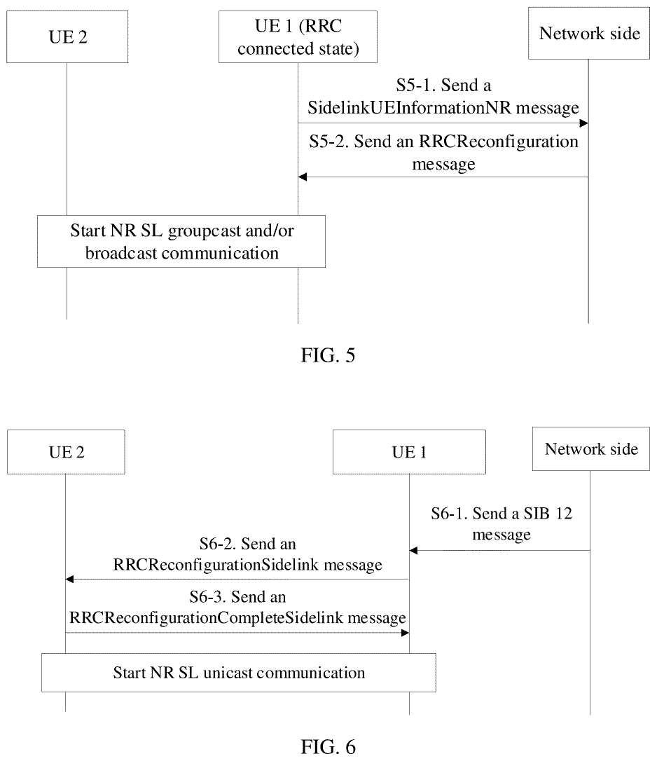

FIG. 5 is a signalling interaction diagram of NR SL groupcast and/or broadcast communication between UE 1 in an RRC connected state and UE 2 in a related technology. As shown in FIG. 5, the following steps are included:

S5-0. UE 1 is in an RRC connected state, and the UE 1 performs NR SL groupcast and/or broadcast communication with UE 2.

S5-1. The UE 1 sends a SidelinkUEInformationNR message to a network, where the SidelinkUEInformationNR message includes a Destination Layer-2 ID, a communication type, a QoS parameter, and an SL frequency of the UE 2 in NR SL communication.

S5-2. The UE 1 receives an RRCReconfiguration message sent by the network, where the RRCReconfiguration message includes an SL-RB related configuration to be applied only to the UE 1.

The SL-RB related configuration to be applied only to the UE 1 takes effect directly on the UE 1.

For the SL-RB related configuration to be applied to both the UE 1 and the UE 2, the UE 1 and the UE 2 apply protocol-specified values. For example, a length of a Packet Data Convergence Protocol (PDCP) Sequence Number (SN) is fixed to 12 bits, a length of a Radio Link Control (RLC) SN is fixed to 6 bits, and an RLC mode is fixed to an Unacknowledged Mode (UM).

After S5-2, the UE 1 starts NR SL groupcast and/or broadcast communication with the peer UE (UE 2).

Type 2: UE 1 is in an RRC inactive state (RRC_INACTIVE) or an idle state (RRC_IDLE), and an SL-RB related configuration is sourced from a configuration of a System Information Block (SIB) 12 of a network side device.

Case 2a: UE 1 performs NR SL unicast communication with UE 2.

FIG. 6 is a signalling interaction diagram of NR SL unicast communication between UE 1 in an RRC inactive state or an idle state and UE 2 in a related technology. As shown in FIG. 6, the following steps are included:

S6-0. UE 1 is in an RRC inactive state or an idle state, and the UE 1 performs NR SL unicast communication with peer UE (UE 2).

S6-1. The UE 1 receives a SIB 12 message sent by a network, where the SIB 12 message includes SL-RB related configurations classified into an SL-RB related configuration to be applied only to the UE 1 and an SL-RB related configuration to be applied to both the UE 1 and the UE 2.

The SL-RB related configuration to be applied only to the UE 1 takes effect directly on the UE 1.

S6-2. In the case of unicast, the UE 1 sends, to the UE 2 through an RRCReconfigurationSidelink message, the SL-RB related configuration that is included in the SIB 12 message and to be applied to both the UE 1 and the UE 2.

S6-3. The UE 1 receives an RRCReconfigurationCompleteSidelink message fed back by the UE 2.

The SL-RB related configuration to be applied to both the UE 1 and the UE 2 takes effect after the RRCReconfigurationCompleteSidelink message is determined.

After S6-3, the UE 1 starts NR SL unicast communication with the UE 2.

Case 2b: UE 1 performs NR SL groupcast and/or broadcast communication with UE 2.

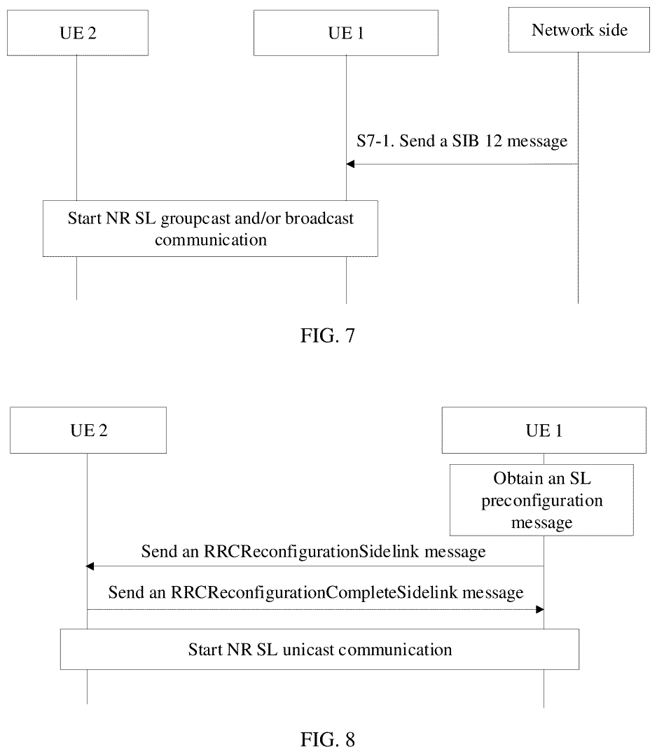

FIG. 7 is a signalling interaction diagram of NR SL groupcast and/or broadcast communication between UE 1 in an RRC inactive state or an idle state and UE 2 in a related technology. As shown in FIG. 7, the following steps are included:

S7-0. UE 1 is in an RRC inactive state or an idle state, and the UE 1 performs NR SL groupcast and/or broadcast communication with UE 2.

S7-1. The UE 1 receive a SIB 12 message sent by a network, where the SIB 12 message includes SL-RB related configurations classified into an SL-RB related configuration to be applied only to the UE 1 and an SL-RB related configuration to be applied to both the UE 1 and the UE 2.

The SL-RB related configuration to be applied only to the UE 1 takes effect directly on the UE 1.

In the case of groupcast and/or broadcast, for the SL-RB related configuration to be applied to both the UE 1 and the UE 2, the UE 1 and the UE 2 apply protocol-specified values. For example, a length of a PDCP SN is fixed to 12 bits, a length of an RLC SN is fixed to 6 bits, and an RLC mode is fixed to UM.

After S7-1, the UE 1 starts NR SL groupcast and/or broadcast communication with the UE 2.

Type 3: UE 1 is in an Out-Of-Coverage (OOC) state, and an SL-RB related configuration is sourced from a configuration of an SL preconfiguration message (SL-PreconfigurationNR).

Case 3a: UE 1 performs NR SL unicast communication with UE 2.

FIG. 8 is a signalling interaction diagram of NR SL unicast communication between UE 1 in an OOC state and UE 2 in a related technology, as shown in FIG. 8.

It should be noted that steps herein are similar to those in case 2a. However, in case 2a, the UE 1 applies an SL-RB common configuration of the network side device based on the SIB 12, but the UE 1 is out of network coverage and cannot obtain the SIB 12. Hence, the UE 1 obtains the SL-RB related configuration based on the SL preconfiguration message. Steps are not described herein again.

Case 3b: UE 1 performs NR SL groupcast and/or broadcast communication with UE 2.

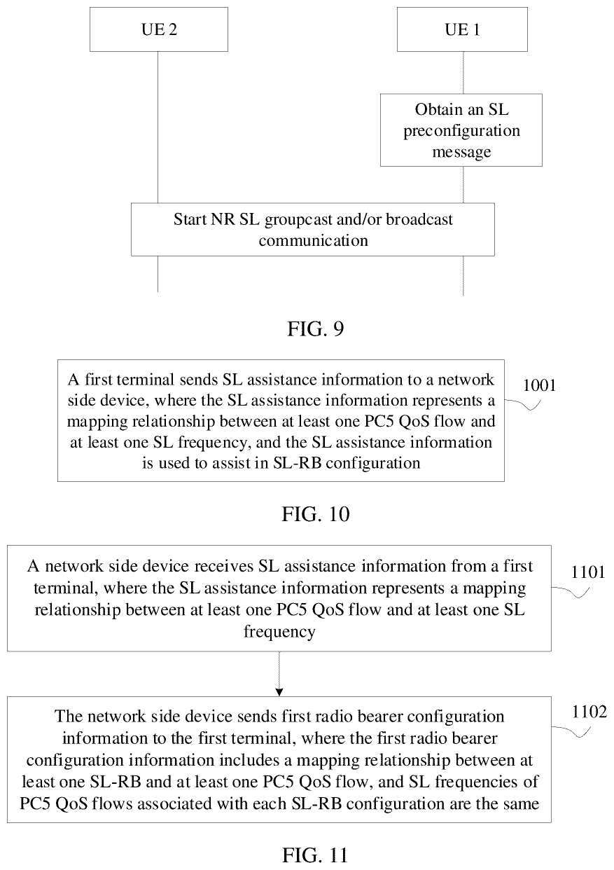

FIG. 9 is a signalling interaction diagram of NR SL groupcast and/or broadcast communication between UE 1 in an OOC state and UE 2 in a related technology, as shown in FIG. 9.

It should be noted that steps herein are similar to those in case 2b. However, in case 2b, the UE 1 may apply an SL-RB common configuration of the network side device based on the SIB 12, but the UE 1 is out of network coverage and cannot obtain the SIB 12. Hence, the UE 1 obtains the SL-RB related configuration based on the SL preconfiguration message. Steps are not described herein again.

With reference to the accompanying drawings, the following describes in detail the SL configuration assistance method, the first terminal, and the network side device provided in the embodiments of this application by using some embodiments and application scenarios thereof.

The SL configuration assistance method corresponding to the first terminal in an RRC connected state is first described.

FIG. 10 is a first schematic flowchart of an SL configuration assistance method according to an embodiment of this application. As shown in FIG. 10, the SL configuration assistance method is applied to a first terminal and the method includes step 1001.

Step 1001: A first terminal sends SL assistance information to a network side device, where the SL assistance information represents a mapping relationship between at least one PC5 QoS flow and at least one SL frequency, and the SL assistance information is used to assist in SL-RB configuration.

In a related technology, in an LTE SL CA framework, an upper layer determines a mapping relationship between a service and a frequency, and provides an AS with a mapping between a Destination L2 ID and an SL frequency.

However, for the mapping relationship between the service and the frequency, NR SL CA needs to consider a case that different QoS flows in the service may use different SL frequencies. Therefore, the LTE SL CA framework cannot be reused in an NR SL CA scenario.

For example, it may be considered that a granularity of a PC5 QoS flow needs to be added to determine the mapping relationship between the service and the frequency by an NR SL upper layer, so that a mapping result finally provided for the AS should be a mapping between {Destination L2 ID, QoS flow} and an SL frequency.

With support for the mapping between {Destination L2 ID, QoS flow} and the SL frequency, the following technical concept is proposed in this application: A mechanism needs to be designed to ensure that PC5 QoS flows with different SL frequencies cannot be mapped to a same SL-RB. Herein, a quantity of SL frequencies may be any positive integer greater than or equal to 1, and a set formed by a frequency value of at least one SL frequency is referred to as an SL frequency set. Therefore, when the quantity of SL frequencies exceeds 1, different SL frequencies mean that at least one SL frequency value in the SL frequency set is different.

In this embodiment of this application, the first terminal may be in an RRC connected state (RRC_CONNECTED state). For SL UE in an RRC_CONNECTED state, a mechanism in which a base station configures an SL radio bearer in a related technology is mapping PC5 QoS flows with a same or similar QoS parameter to a same SL-RB. In an SL CA scenario, if the mechanism in the related technology is not improved, an SL-RB configuration configured by the base station may conflict with an upper-layer configuration, and consequently the SL CA cannot work.

For example, an SL-RB configuration configured by the base station is associated with a PC5 QoS flow-1, a PC5 QoS flow-2, and a PC5 QoS flow-3, and an upper layer of the UE provides an AS with a mapping in which the PC5 QoS flow-1 and the PC5 QoS flow-3 are mapped to an SL freq-1 and the PC5 QoS flow-2 is mapped to an SL freq-2. In addition, an SL frequency selection mechanism is executed at a Medium Access Control (MAC) layer. However, the MAC layer can distinguish only a logical channel level but not a QoS flow level, that is, different QoS flows delivered to a same logical channel can only be treated equally at the MAC layer. Therefore, the SL frequency selection mechanism at the MAC layer cannot work based on a frequency specified by the upper layer.

For the current problem of the first terminal in an RRC connected state, in this embodiment of this application, through reporting of assistance information of the SL UE and the configuration of the base station, it is ensured that PC5 QoS flows with different SL frequencies are mapped to different SL-RB configurations. In other words, any PC5 QoS flow associated with a same SL-RB is mapped to a same SL frequency. A final effect of this embodiment of this application may be, for example, that the base station configures an SL-RB-1 configuration to be associated with the PC5 QoS flow-1 and the PC5 QoS flow-3 (associated with the SL freq-1), and the base station configures an SL-RB-2 configuration to be associated with the PC5 QoS flow-2 (associated with the SL freq-2), so that PC5 QoS flows of different SL frequencies are mapped to different SL-RBs and PC5 QoS flows of a same SL frequency are mapped to a same SL-RB.

For example, the first terminal may send the SL assistance information to the network side device, to assist in SL-RB configuration. The SL assistance information may represent the mapping relationship between the at least one PC5 QoS flow and the at least one SL frequency, and the network side device may perform SL-RB configuration by using the mapping relationship represented by the SL assistance information.

In some embodiments, before the first terminal sends the SL assistance information to the network side device, the first terminal may receive first configuration information from an upper layer of the first terminal, where the first configuration information includes the mapping relationship between the at least one PC5 QoS flow and the at least one SL frequency; and
the first terminal determines the SL assistance information based on the first configuration information, where
the upper layer is a protocol layer above an access stratum of the first terminal.

For example, the upper layer may generally refer to the collective term for protocol layers above a 3rd Generation Partnership Project (3GPP) AS. For example, the upper layer may include a V2X service layer, a Proximity Service (ProSe) layer, and the like.

In some embodiments, the SL assistance information may include any one of the following:
(1) a first mapping relationship among a Destination Layer-2 ID, at least one PC5 QoS flow identity, and at least one SL frequency; and
(2) a second mapping relationship between the at least one PC5 QoS flow identity and the at least one SL frequency.

In some embodiments, the SL assistance information may further include at least one of the Destination Layer-2 ID, the at least one PC5 QoS flow identity, and the at least one SL frequency, that is, the SL assistance information may include any combination of at least one of the foregoing items and the first mapping relationship or the second mapping relationship.

In some embodiments, the SL assistance information may be carried in a SidelinkUEInformationNR message sent by the first terminal to the network side device.

In some embodiments, the first mapping relationship may meet any one of the following:
a. Based on a first combination of the Destination Layer-2 ID and a part of the at least one PC5 QoS flow identity, at least one SL frequency corresponding to the first combination is determined.

For example, the at least one SL frequency may be uniquely determined based on the combination of the Destination Layer-2 ID and the part of the at least one PC5 QoS flow identity, that is, a mapping relationship among the Destination Layer-2 ID, the PC5 QoS flow identity, and the SL frequency may be 1:N:M, where N is greater than or equal to 1, and M is greater than or equal to 1.

It should be noted that one Destination Layer-2 ID may correspond to a plurality of PC5 QoS flow identities, and the Destination Layer-2 ID and any PC5 QoS flow identity may be used as the first combination to uniquely determine the at least one SL frequency.
b. Based on a second combination of the Destination Layer-2 ID and a part of the at least one SL frequency, at least one PC5 QoS flow identity corresponding to the second combination is determined.

For example, the at least one PC5 QoS flow identity may be uniquely determined based on the combination of the Destination Layer-2 ID and the part of the at least one SL frequency, that is, a mapping relationship among the Destination Layer-2 ID, the PC5 QoS flow identity, and the SL frequency is 1:L:K, where L is greater than or equal to 1, and K is greater than or equal to 1.

It should be noted that one Destination Layer-2 ID may correspond to a plurality of SL frequencies, and the Destination Layer-2 ID and any SL frequency may be used as the second combination to uniquely determine the at least one PC5 QoS flow identity.

In some embodiments, the second mapping relationship may meet any one of the following:
(a) based on a third combination of a part of the at least one PC5 QoS flow identity, at least one SL frequency corresponding to the third combination is determined; and
(b) based on a fourth combination of a part of the at least one SL frequency, at least one PC5 QoS flow identity corresponding to the fourth combination is determined.

In this embodiment of this application, an SL configuration assistance method applicable to an NR SL CA scenario is provided. For example, a first terminal sends SL assistance information to a network side device, where the SL assistance information represents a mapping relationship between at least one PC5 QoS flow and at least one SL frequency. Therefore, the network side device may assist in SL-RB configuration by using the mapping relationship represented by the SL assistance information, thereby adapting to a granularity of a PC5 QoS flow level of an NR SL. That is, a frequency mapping method at a PC5 QoS flow level is proposed, so that after SL-RB configuration is performed by using the mapping relationship, the first terminal can work based on a frequency specified by an upper layer protocol of the terminal to implement accurate configuration of an SL radio bearer in the NR SL CA scenario.

In some embodiments, the first terminal may receive first radio bearer configuration information from the network side device; and
the first terminal performs an operation of applying the first radio bearer configuration information, where the first radio bearer configuration information includes a mapping relationship between at least one SL-RB and at least one PC5 QoS flow, and SL frequencies of PC5 QoS flows associated with each SL-RB configuration are the same.

In some embodiments, after the first terminal sends the SL assistance information to the network side device, the first terminal may receive the first radio bearer configuration information from the network side device. In some implementations, the first radio bearer configuration information may be modified based on the SL assistance information or may be generated based on the SL assistance information.

In this embodiment of this application, it may be understood that applying the first radio bearer configuration information includes at least the following two meanings:
(1) the first terminal considers that the first radio bearer configuration information is valid; and
(2) the first terminal performs an SL-RB configuration operation on a to-be-transmitted target PC5 Qos flow based on the first radio bearer configuration information.

The to-be-transmitted target PC5 Qos flow may be configured by a protocol layer above the access stratum of the first terminal, and the performing an SL-RB configuration operation may include at least one of an SL-RB addition operation and an SL-RB modification operation.

For example, after receiving the first radio bearer configuration information from the network side device, the first terminal may assume that the network side device has determined that the first radio bearer configuration information meets the requirement. That is, SL frequencies of PC5 QoS flows associated with each SL-RB configuration in the mapping relationship that is between the at least one SL-RB and the at least one PC5 QoS flow and included in the first radio bearer configuration information are the same, and the first terminal may directly perform the operation of applying the first radio bearer configuration information that meets the requirement.

It should be noted that, whether the first radio bearer configuration information meets the requirement needs to be determined for each SL-RB configuration in the first radio bearer configuration information. That is, each SL-RB configuration is used as a determining unit to determine whether SL frequencies of a plurality of PC5 QoS flows associated with each SL-RB configuration are the same.

For example, it is assumed that an SL-RB 1 in the first radio bearer configuration information is associated with a PC5 QoS flow-1 (corresponding to frequencies f1 and f2) and a PC5 QoS flow-2 (corresponding to the frequencies f1 and f2). For the SL-RB 1, because SL frequencies corresponding to the PC5 QoS flow-1 and the PC5 QoS flow-2 are the same, it may be considered that the SL-RB 1 meets the requirement. Further, it is assumed that an SL-RB 2 in the first radio bearer configuration information is associated with a PC5 QoS flow-3 (corresponding to the frequencies f1 and f2) and a PC5 QoS flow-4 (corresponding to a frequency f3). For the SL-RB 2, because SL frequencies corresponding to the PC5 QoS flow-3 and the PC5 QoS flow-4 are different, it may be considered that the SL-RB 2 does not meet the requirement. It should be noted that frequency information in the first radio bearer configuration information may be explicitly carried in the first radio bearer configuration information of the network side device, or may be implicitly derived by the first terminal with reference to the mapping relationship that is between the at least one PC5 QoS flow and the at least one frequency and configured by the upper layer of the terminal. This is not limited herein in this application.

If all SL-RBs in the first radio bearer configuration information meet the requirement, it may be considered that the first radio bearer configuration information meets the requirement; or if one SL-RB does not meet the requirement, it may be considered that the first radio bearer configuration information does not meet the requirement.

In some embodiments, the first terminal may receive first radio bearer configuration information from the network side device;
the first terminal determines a determining result based on whether the first radio bearer configuration information meets a first condition; and
the first terminal performs a corresponding target operation based on the determining result, where
the first condition includes: the first radio bearer configuration information includes a mapping relationship between at least one SL-RB and at least one PC5 QoS flow, and SL frequencies of PC5 QoS flows associated with each SL-RB configuration are the same.

In some embodiments, after the first terminal sends the SL assistance information to the network side device, the first terminal may receive the first radio bearer configuration information from the network side device. In some implementations, the first radio bearer configuration information may be modified based on the SL assistance information or may be generated based on the SL assistance information.

For example, after receiving the first radio bearer configuration information from the network side device, the first terminal may further determine whether the first radio bearer configuration information meets the first condition, that is, determine whether SL frequencies of PC5 QoS flows associated with each SL-RB configuration in the mapping relationship that is between the at least one SL-RB and the at least one PC5 QoS flow and included in the first radio bearer configuration information are the same, and perform the corresponding target operation based on the determining result.

In some embodiments, when the determining result is that the first radio bearer configuration information meets the first condition, the target operation may include: applying the first radio bearer configuration information; and
when the determining result is that the first radio bearer configuration information does not meet the first condition, the target operation may include at least one of the following operations:
(1) considering that the first radio bearer configuration information is invalid;
(2) considering that an RRC reconfiguration procedure corresponding to the first radio bearer configuration information fails;
(3) triggering an RRC re-establishment procedure; and
(4) sending radio bearer-related configuration failure information to the network side device.

For example, if the first terminal determines that the first radio bearer configuration information meets the first condition, the first terminal performs the operation of applying the first radio bearer configuration information.

If the first terminal determines that the first radio bearer configuration information does not meet the first condition, it may be considered that the first radio bearer configuration information makes it difficult for the first terminal to work based on a frequency specified by the upper layer, and that an NR SL CA mechanism is difficult to work normally. Therefore, the first terminal may consider that the first radio bearer configuration information is invalid or that the RRC reconfiguration procedure corresponding to the first radio bearer configuration information fails. Further, the RRC re-establishment procedure may be triggered, so that the network side device re-performs RRC reconfiguration and redelivers new first radio bearer configuration information. In some alternative embodiments, the radio bearer-related configuration failure information may be sent to the network side device. The radio bearer-related configuration failure information may further indicate a radio bearer-related configuration failure cause and/or which SL-RB configuration(s) have failed.

In some embodiments, the first terminal may consider that the first radio bearer configuration information is invalid by considering that RRC reconfiguration content carried in the first radio bearer configuration information that does not meet the first condition is not valid.

In some embodiments, after determining that the first radio bearer configuration information does not meet the first condition, the first terminal may trigger a Sidelink UE Information procedure, and report SL radio bearer-related configuration failure information by using a SidelinkUEInformationNR message.

In some embodiments, an implementation in which the first terminal sends the SL assistance information to the network side device may include:
sending, by the first terminal, the SL assistance information to the network side device when it is determined that a second condition is met, where
the second condition includes at least one of the following:
a. the network side device supports SL multi-carrier transmission;
b. the network side device supports an SL CA function;
c. the mapping relationship changes relative to the last SL assistance information sent by the first terminal; and
d. the at least one PC5 QoS flow is used for SL unicast communication.

For example, when determining that the second condition is met, the first terminal may send the SL assistance information to the network side device. This may be classified into the following three cases:
Case 1: Before sending the SL assistance information to the network side device, the first terminal first checks whether the network side device supports the SL multi-carrier transmission or the SL CA function, and then sends the SL assistance information to the network side device when a check result is “Yes”. When the check result is “No”, it may be considered that the network side device does not need to perform SL-RB configuration by using the SL assistance information, and therefore the SL assistance information may not be sent to the network side device.
Case 2: Before sending the SL assistance information to the network side device, the first terminal first performs a check. If the first terminal has already sent the SL assistance information to the network side device, it is determined whether the mapping relationship that is between the at least one PC5 QoS flow and the at least one SL frequency and represented by the SL assistance information changes compared with the last SL assistance information sent. If the mapping relationship does not change, the SL assistance information may not be sent. If the mapping relationship changes, the SL assistance information is sent.
Case 3: Before sending the SL assistance information to the network side device, the first terminal first performs a check. If the SL assistance information to be sent by the first terminal to the network side device is relevant to SL unicast communication, the SL assistance information is sent to the network side device. If the SL assistance information is irrelevant to SL unicast communication such as SL broadcast communication or SL groupcast communication, it may be considered that the network side device may obtain a mapping relationship between a PC5 QoS flow and SL frequency information in advance in another manner (for example, in an Operation and Maintenance (OAM) manner or being configured by a core network for the network side device through a terminal policy), without being reported through a radio air interface of the terminal.

FIG. 11 is a second schematic flowchart of an SL configuration assistance method according to an embodiment of this application. As shown in FIG. 11, the SL configuration assistance method is applied to a network side device and the method includes steps 1101 and 1102.

Step 1101: A network side device receives SL assistance information from a first terminal, where the SL assistance information represents a mapping relationship between at least one PC5 QoS flow and at least one SL frequency.

Step 1102: The network side device sends first radio bearer configuration information to the first terminal, where the first radio bearer configuration information includes a mapping relationship between at least one SL-RB and at least one PC5 QoS flow, and SL frequencies of PC5 QoS flows associated with each SL-RB configuration are the same.

For example, the first terminal first sends the SL assistance information to the network side device, where the SL assistance information represents the mapping relationship between the at least one PC5 QoS flow and the at least one SL frequency. The network side device may determine the first radio bearer configuration information based on the SL assistance information, where the first radio bearer configuration information includes the mapping relationship between the at least one SL-RB and the at least one PC5 QoS flow, and the SL frequencies of the PC5 QoS flows associated with each SL-RB configuration are the same; and then send the first radio bearer configuration information to the first terminal, so that the first terminal performs corresponding terminal behavior based on the first radio bearer configuration information.

In some embodiments, the SL assistance information may include any one of the following:
(1) a first mapping relationship among a Destination Layer-2 ID, at least one PC5 QoS flow identity, and at least one SL frequency; and
(2) a second mapping relationship between the at least one PC5 QoS flow identity and the at least one SL frequency.

In some embodiments, the SL assistance information may further include at least one of the Destination Layer-2 ID, the at least one PC5 QoS flow identity, and the at least one SL frequency, that is, the SL assistance information may include any combination of at least one of the foregoing items and the first mapping relationship or the second mapping relationship.

In some embodiments, the first mapping relationship may meet any one of the following:
a. based on a first combination of the Destination Layer-2 ID and a part of the at least one PC5 QoS flow identity, at least one SL frequency corresponding to the first combination is determined; and
b. based on a second combination of the Destination Layer-2 ID and a part of the at least one SL frequency, at least one PC5 QoS flow identity corresponding to the second combination is determined.

In some embodiments, the second mapping relationship may meet any one of the following:
(a) based on a third combination of a part of the at least one PC5 QoS flow identity, at least one SL frequency corresponding to the third combination is determined; and
(b) based on a fourth combination of a part of the at least one SL frequency, at least one PC5 QoS flow identity corresponding to the fourth combination is determined.

In this embodiment of this application, an SL configuration assistance method applicable to an NR SL CA scenario is provided. For example, a network side device receives SL assistance information from a first terminal, where the SL assistance information represents a mapping relationship between at least one PC5 QoS flow and at least one SL frequency. Therefore, the network side device may assist in SL-RB configuration based on the mapping relationship represented by the SL assistance information. For example, first radio bearer configuration information is sent to the first terminal, where SL frequencies of PC5 QoS flows associated with each SL radio bearer SL-RB in the first radio bearer configuration information are the same, to ensure that PC5 QoS flows with different SL frequencies are not mapped to a same SL-RB, thereby adapting to a granularity of a PC5 QoS flow level of an NR SL. That is, a frequency mapping method at a PC5 QoS flow level is proposed, so that after SL-RB configuration is performed by using the mapping relationship, the first terminal can work based on a frequency specified by an upper layer protocol of the terminal to implement accurate configuration of an SL radio bearer in the NR SL CA scenario.

An implementation in which the network side device sends the first radio bearer configuration information to the first terminal may include:
determining, by the network side device, the first radio bearer configuration information based on first information; and
sending, by the network side device, the first radio bearer configuration information to the first terminal, where
the first information includes at least one of the following:
(1) a QoS parameter requirement of the at least one PC5 QoS flow; and
(2) the mapping relationship represented by the SL assistance information.

For example, for a mechanism in a related technology, PC5 QoS flows with similar QoS parameter requirements are configured into one SL-RB, and PC5 QoS flows with different or significantly distinct QoS parameter requirements are configured into different SL-RBs. Classification of QoS requirements of PC5 QoS flows and a quantity of SL-RBs required to accomplish such classification are implementation of the network side device. It is assumed that classification based on QoS parameter requirements is as follows:
a PC5 QoS flow-1, a PC5 QoS flow-2, and a PC5 QoS flow-3 are configured into an SL-RB 1;
a PC5 QoS flow-4 and a PC5 QoS flow-5 are configured into an SL-RB 2; and
a PC5 QoS flow-6 is configured into an SL-RB 3.

Based on the mechanism in the related technology, three SL-RBs are configured.

In the mechanism proposed in this application, in addition to similar QoS, QoS flows that have similar QoS but are associated with different frequencies need to be configured into different SL-RBs. It is assumed that classification based on QoS parameter requirements and frequencies is as follows:
a PC5 QoS flow-1 (corresponding to frequencies f1 and f2) and a PC5 QoS flow-2 (corresponding to the frequencies f1 and f2) are configured into an SL-RB 1;
a PC5 QoS flow-3 (corresponding to a frequency f3) is configured into an SL-RB 2;
a PC5 QoS flow-4 (corresponding to the frequency f3) and a PC5 QoS flow-5 (corresponding to the frequency f3) are configured into an SL-RB3; and
a PC5 QoS flow-6 (corresponding to a frequency f4) is configured into an SL-RB4.

According to the mechanism proposed in this application, four SL-RBs are configured. A difference from the mechanism in the related technology mainly lies in that, although QoS parameter requirements of the PC5 QoS flow-1, the PC5 QoS flow-2, and the PC5 QoS flow-3 are similar, frequencies separately corresponding to the PC5 QoS flow-1, the PC5 QoS flow-2, and the PC5 QoS flow-3 are different. Therefore, the PC5 QoS flow-1 and the PC5 QoS flow-2 corresponding to the same frequency are configured into a same SL-RB, and the PC5 QoS flow-3 corresponding to a different frequency is configured into another SL-RB.

The following describes the SL configuration assistance method corresponding to the first terminal in an RRC idle state/inactive state or out of network coverage.

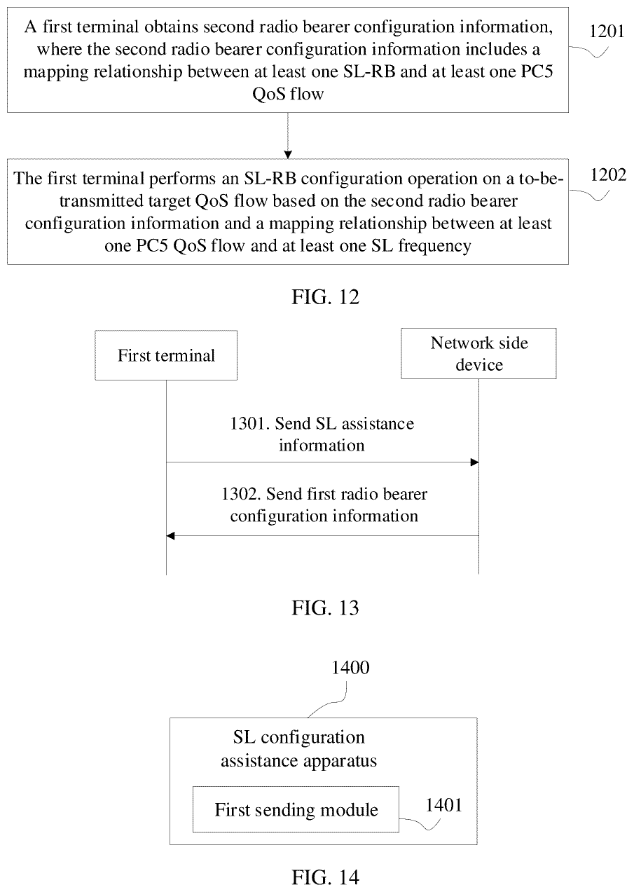

FIG. 12 is a third schematic flowchart of an SL configuration assistance method according to an embodiment of this application. As shown in FIG. 12, the SL configuration assistance method is applied to a first terminal and the method includes step 1201 and step 1202.

Step 1201: A first terminal obtains second radio bearer configuration information, where the second radio bearer configuration information includes a mapping relationship between at least one SL-RB and at least one PC5 QoS flow.

Step 1202: The first terminal performs an SL-RB configuration operation on a to-be-transmitted target QoS flow based on the second radio bearer configuration information and a mapping relationship between at least one PC5 QoS flow and at least one SL frequency.

For example, the first terminal may obtain the second radio bearer configuration information, where the second radio bearer configuration information includes the mapping relationship between the at least one SL-RB and the at least one PC5 QoS flow. The first terminal may further receive first configuration information from an upper layer of the first terminal, where the first configuration information includes the mapping relationship between the at least one PC5 QoS flow and the at least one SL frequency. Therefore, the first terminal may perform the SL-RB configuration operation on the to-be-transmitted target QoS flow based on the mapping relationship included in the second radio bearer configuration information and the mapping relationship included in the first configuration information.

It should be noted that, it is assumed that an SL-RB configuration is associated with a PC5 QoS flow-1, a PC5 QoS flow-2, and a PC5 QoS flow-3, and the plurality of PC5 QoS flows arrive successively in terms of time. The to-be-transmitted target QoS flow is a QoS flow to be transmitted at a current time.

In this embodiment of this application, an SL configuration assistance method applicable to an NR SL CA scenario is provided. For example, a first terminal obtains second radio bearer configuration information, where the second radio bearer configuration information includes a mapping relationship between at least one SL-RB and at least one PC5 QoS flow. Therefore, the first terminal may perform an SL-RB configuration operation on a to-be-transmitted target QoS flow based on the second radio bearer configuration information and a mapping relationship between at least one PC5 QoS flow and at least one SL frequency, thereby adapting to a granularity of a PC5 QoS flow level of an NR SL. That is, a frequency mapping method at a PC5 QoS flow level is proposed, so that after the SL-RB configuration operation is performed on the to-be-transmitted target QoS flow by using the mapping relationship, the first terminal can work based on a frequency specified by an upper layer protocol of the terminal to implement accurate configuration of an SL radio bearer in the NR SL CA scenario.

An implementation in which the first terminal performs the SL-RB configuration operation on the to-be-transmitted target QoS flow based on the second radio bearer configuration information and the mapping relationship between the at least one PC5 QoS flow and the at least one SL frequency may include:
performing, by the first terminal, an SL-RB addition operation when determining, based on the second radio bearer configuration information and the mapping relationship between the at least one PC5 QoS flow and the at least one SL frequency, that the target QoS flow meets a third condition, where
the third condition includes any one of the following:
(1) an SL-RB to which the target QoS flow is mapped has not been established; and
(2) the SL-RB to which the target QoS flow is mapped has been established, and an SL frequency set to which the target QoS flow is mapped is different from an SL frequency set to which the established target SL-RB is mapped.

For example, when the first terminal determines, based on the second radio bearer configuration information and the mapping relationship between the at least one PC5 QoS flow and the at least one SL frequency, that the target QoS flow meets the third condition, for example, if the SL-RB to which the target QoS flow is mapped has not been established or the SL-RB to which the target QoS flow is mapped has been established but the SL frequency set to which the target QoS flow is mapped is different from the SL frequency set to which the established target SL-RB is mapped, an SL-RB addition operation may be performed.

For example, according to a requirement of an upper-layer configuration of the first terminal, a PC5 QoS flow-1 is mapped to an SL freq-1 and an SL freq-2, a PC5 QoS flow-2 is mapped to the SL freq-1 and the SL freq-2, and a PC5 QoS flow-3 is mapped to an SL freq-3. Assuming that the PC5 QoS flow-1, the PC5 QoS flow-2, and the PC5 QoS flow-3 arrive successively in terms of time, for the first arriving PC5 QoS flow-1, if an SL-RB to which the PC5 QoS flow-1 is mapped has not been established, an SL-RB addition operation may be performed. Then, for the PC5 QoS flow-2 that arrives next, because the SL freq-1 and the SL freq-2 to which the PC5 QoS flow-2 is mapped are the same as frequencies to which the PC5 QoS flow-1 is mapped, it is unnecessary to perform an SL-RB addition operation on the PC5 QoS flow-2, that is, no new SL-RB needs to be added to be corresponding to the PC5 QoS flow-2. Then, for the next-arriving PC5 QoS flow-3, because the SL freq-3 to which the PC5 QoS flow-3 is mapped is different from frequencies to which the PC5 QoS flow-1 and the PC5 QoS flow-2 are mapped, and does not belong to a subset of the SL frequency set to which the established target SL-RB is mapped, an SL-RB addition operation may be performed on the PC5 QoS flow-3, to establish a new SL-RB to be corresponding to the PC5 QoS flow-3.

The following uses examples to describe that the SL frequency set to which the target QoS flow is mapped is different from the SL frequency set to which the established target SL-RB is mapped.

Example 1: For the PC5 QoS flow-1 (mapped to a frequency set f1 and f2) and the target PC5 QoS flow-2 (mapped to a frequency set f1), this case in which one set is a subset of the other may be interpreted as “different”.

Example 2: For the PC5 QoS flow-1 (mapped to a frequency set f1 and f2) and the target PC5 QoS flow-2 (mapped to a frequency set f3), this case of completely disjoint sets may also be interpreted as “different”.

It should be noted that, for “performing an SL-RB addition operation”, in the first case (the SL-RB to which the target QoS flow is mapped has not been established), a new SL-RB is established and the target QoS flow is mapped to the new SL-RB for transmission; or in the second case (the SL-RB to which the target QoS flow is mapped has been established), a new SL-RB is established and the new SL-RB is different from the established target SL-RB, and the target QoS flow is mapped to the new SL-RB for transmission.

In some embodiments, if the first terminal communicates with a second terminal through SL unicast, the first terminal may send a first message to the second terminal when the target QoS flow meets the third condition, where the first message carries first indication information used to instruct to perform an SL-RB addition operation.

For example, if the first terminal communicates with the second terminal through SL unicast, the first terminal may send the first message to the second terminal when the target QoS flow meets the third condition, that is, when an addition operation needs to be performed on the target QoS flow, where the first message carries the first indication information used to instruct to perform an SL-RB addition operation, so as to instruct the second terminal to perform a related operation.

In some embodiments, the first message may be an RRCReconfigurationSidelink message.

If the first terminal communicates with the second terminal through SL groupcast or broadcast, the first terminal does not need to send the first message to the second terminal.

An implementation in which the first terminal performs the SL-RB configuration operation on the to-be-transmitted target QoS flow based on the second radio bearer configuration information and the mapping relationship between the at least one PC5 QoS flow and the at least one SL frequency may include:
performing, by the first terminal, an SL-RB modification operation when determining, based on the second radio bearer configuration information and the mapping relationship between the at least one PC5 QoS flow and the at least one SL frequency, that the target QoS flow meets a fourth condition, where
the fourth condition includes: an SL-RB to which the target QoS flow is mapped has been established, and an SL frequency set to which the target QoS flow is mapped is the same as an SL frequency set to which the established target SL-RB is mapped.

For example, when the first terminal determines, based on the second radio bearer configuration information and the mapping relationship between the at least one PC5 QoS flow and the at least one SL frequency, that the target QoS flow meets the fourth condition, for example, if the SL-RB to which the target QoS flow is mapped has been established, and the SL frequency set to which the target QoS flow is mapped is the same as the SL frequency set to which the established target SL-RB is mapped, an SL-RB modification operation may be performed.

For example, it is assumed that a PC5 QoS flow-1 and a PC5 QoS flow-2 arrive successively in terms of time, the PC5 QoS flow-1 is mapped to an SL freq-1 and an SL freq-2, and the PC5 QoS flow-2 is mapped to the SL freq-1 and the SL freq-2. For the first arriving PC5 QoS flow-1, if an SL-RB to which the PC5 QoS flow-1 is mapped has not been established, an SL-RB addition operation may be performed. Then, for the next arriving PC5 QoS flow-2, because the SL freq-1 and the SL freq-2 to which the PC5 QoS flow-2 is mapped are the same as frequencies to which the PC5 QoS flow-1 is mapped, a modification operation may be performed on the SL-RB corresponding to the PC5 QoS flow-1, to map the PC5 QoS flow-2 to the SL-RB corresponding to the PC5 QoS flow-1.

The following uses an example to describe that the SL frequency set to which the target QoS flow is mapped is the same as the SL frequency set to which the established target SL-RB is mapped. For the PC5 QoS flow-1 (mapped to a frequency set f1 and f2) and the target PC5 QoS flow-2 (mapped to the frequency set f1 and f2), this case in which all elements in the set are the same may be interpreted as ‘same’.

It should be noted that, “performing an SL-RB modification operation” means that a new SL-RB is not additionally established, but on the established target SL-RB, the target QoS flow is also mapped to the target SL-RB for transmission.

In some embodiments, if the first terminal communicates with the second terminal through SL unicast, the first terminal may send a second message to the second terminal when the target QoS flow meets the fourth condition, where the second message carries second indication information used to instruct to perform an SL-RB modification operation.

For example, if the first terminal communicates with the second terminal through SL unicast, the first terminal may send the second message to the second terminal when the target QoS flow meets the fourth condition, that is, when a modification operation needs to be performed on the target QoS flow, where the second message carries the second indication information used to instruct to perform an SL-RB modification operation, to instruct the second terminal to perform a related operation.

In some embodiments, the second message may be an RRCReconfigurationSidelink message.

If the first terminal communicates with the second terminal through SL groupcast or broadcast, the first terminal does not need to send the second message to the second terminal.

In some embodiments, the first terminal may receive second configuration information from an upper layer of the first terminal, where
the upper layer is a protocol layer above an access stratum of the first terminal, and the second configuration information includes at least one of the following:
a. the mapping relationship between the at least one PC5 QoS flow and the at least one SL frequency; and
b. the to-be-transmitted target QoS flow.

An implementation in which the first terminal obtains the second radio bearer configuration information may include:
receiving a SIB message from a network side device when the first terminal is in an RRC idle state or an RRC inactive state, where the SIB message includes the second radio bearer configuration information; and
obtaining the second radio bearer configuration information through an SL preconfiguration message when the first terminal is out of network coverage.

For example, when the first terminal is in an RRC idle state or an RRC inactive state, the first terminal may obtain the second radio bearer configuration information by receiving the SIB message from the network side device.

When the first terminal is out of network coverage, the first terminal cannot obtain the second radio bearer configuration information by using the network side device, and therefore may obtain the second radio bearer configuration information by using the SL preconfiguration message.

In some embodiments, the second radio bearer configuration information further includes PDCP duplication enable configuration information corresponding to a part or all SL-RBs in the at least one SL-RB.

When it is determined to perform an SL-RB addition operation, if a quantity of SL frequencies associated with a to-be-established first SL-RB is less than a first preset threshold, the first terminal ignores PDCP duplication enable configuration information corresponding to the first SL-RB; and
when it is determined to perform an SL-RB modification operation, if a quantity of SL frequencies associated with a second SL-RB after the SL-RB modification operation is performed is less than a second preset threshold, the first terminal ignores PDCP duplication enable configuration information corresponding to the second SL-RB.

It should be noted that, that the first terminal ignores the PDCP duplication enable configuration information corresponding to the first SL-RB may be understood as not performing a PDCP duplication operation or deactivating PDCP duplication for the first SL-RB.

It should be noted that the first preset threshold and the second preset threshold may be a fixed value based on network configuration, SL preconfiguration, or protocol agreement, and the first preset threshold and the second preset threshold may be the same or different.

For example, assuming a preset threshold=2 and a quantity of SL frequencies=1, the ignore operation is performed. If more than two legs (more than two RLC) are used for future SL PDCP duplication function transmission, this may be applicable to the foregoing case.

For another example, assuming a preset threshold=3 and a quantity of SL frequencies=1 or 2, the ignore operation is performed.

In some embodiments, when it is determined to perform an SL-RB addition operation, currently, an operation corresponding to a duplication enable configuration may be performed only when an SL-RB is associated with a plurality of SL frequencies. Therefore, if the quantity of SL frequencies associated with the to-be-established first SL-RB is 1 (there is one and only one), the first terminal may ignore the PDCP duplication enable configuration information corresponding to the first SL-RB. The SL frequency associated with the to-be-established first SL-RB is determined by an SL frequency to which a PC5 QoS flow is mapped.

Similarly, in some embodiments, when it is determined to perform an SL-RB modification operation, if the quantity of SL frequencies associated with the second SL-RB after the SL-RB modification operation is performed is 1, the first terminal ignores the PDCP duplication enable configuration information corresponding to the second SL-RB. The SL frequency associated with the second SL-RB after the SL-RB modification operation is performed is jointly determined by an SL frequency to which a PC5 QoS flow before the SL-RB modification operation is performed is mapped and an SL frequency to which at least one PC5 QoS flow on the second SL-RB when the SL-RB modification operation is performed is mapped.

FIG. 13 is a signalling interaction diagram of an SL configuration assistance method according to an embodiment of this application. As shown in FIG. 13, the method includes step 1301 and step 1302.

Step 1301: A first terminal sends SL assistance information to a network side device.

The SL assistance information represents a mapping relationship between at least one PC5 quality of service flow QoS flow and at least one SL frequency, and the SL assistance information is used to assist in SL radio bearer SL-RB configuration.

Step 1302: The network side device sends first radio bearer configuration information to the first terminal.

The first radio bearer configuration information includes a mapping relationship between at least one SL radio bearer SL-RB and at least one PC5 QoS flow, and SL frequencies of PC5 QoS flows associated with each SL-RB configuration are the same.

The following uses examples to describe the SL configuration assistance method provided in the embodiments of this application.

Embodiment 1: A transmit end (UE 1) is in an RRC connected state, and an SL-RB related configuration is sourced from a configuration of a dedicated message RRCReconfiguration of a network side device.

A main idea of this embodiment of this application is to ensure that PC5 QoS flows with different SL frequencies are mapped to different SL-RB configurations through SL assistance information reporting+base station configuration. A final effect is, for example, as follows: A base station configures an SL-RB-1 configuration to be associated with a PC5 QoS flow-1 (associated with an SL freq-1), and the base station configures an SL-RB-2 configuration to be associated with a PC5 QoS flow-2 (associated with an SL freq-2).

Steps are executed as follows:

Step 1-0: A transmit end (UE 1) is in an RRC connected state, and the UE 1 performs NR SL communication or NR SL discovery with peer UE (UE 2).

Step 1-1: The UE 1 sends a SidelinkUEInformationNR message to a network side device (for example, a serving base station), where the SidelinkUEInformationNR message includes a Destination Layer-2 ID of the UE 2, at least one PC5 QoS flow identity (PC5-QoS-FlowIdentity), and at least one SL frequency. There is a mapping relationship among the Destination Layer-2 ID, the at least one PC5 QoS flow identity, and the at least one SL frequency.

In some embodiments, the mapping relationship among the three may be implemented in any one of the following manners:
Manner 1: Uniquely determine the at least one SL frequency based on a combination of the Destination Layer-2 ID and the PC5 QoS flow identity. That is, the mapping relationship among the Destination Layer-2 ID, the PC5 QoS flow identity, and the SL frequency is 1:1:M (M is greater than or equal to 1).
Manner 2: Uniquely determine the at least one PC5 QoS flow identity based on a combination of the Destination Layer-2 ID and the SL frequency. That is, the mapping relationship among the Destination Layer-2 ID, the PC5 QoS flow identity, and the SL frequency is 1:M:1 (M is greater than or equal to 1).

Step 1-2: The UE 1 receives an RRCReconfiguration message sent by the serving base station, where the RRCReconfiguration message includes at least one SL-RB related configuration.

The at least one SL-RB related configuration meets or does not meet the following requirement: SL frequencies of PC5 QoS flows associated with each SL-RB in the SL-RB related configuration are the same.

Step 1-3: The UE 1 checks content of the RRCReconfiguration message sent by the serving base station, and performs corresponding terminal behavior.

For example, if a configuration of the serving base station meets the foregoing requirement, the UE 1 applies the content of the RRCReconfiguration message.

If the configuration of the serving base station does not meet the foregoing requirement, the UE 1 triggers any of the following behavior:
(1) The UE 1 considers that RRC reconfiguration content is not valid or an RRC reconfiguration procedure fails. Further, an RRC re-establishment procedure may be triggered.
(2) The UE 1 triggers a Sidelink UE Information procedure and reports SL radio bearer-related configuration failure information through the SidelinkUEInformationNR message.

### Embodiment 2: SL UE in an RRC ILDE State or an RRC INACTIVE State

Core idea: For SL UE in an RRC ILDE state or an RRC INACTIVE state, a radio bearer configuration of the SL UE is based on a SIB configuration. In this application, an additional behavior specification on the SL UE side is introduced. In behavior of establishing an SL radio bearer, for example, when PC5 QoS flows are mapped to different SL frequencies, an additional SL radio bearer is triggered to be established. A final effect is, for example, an SL-RB configuration in a SIB is associated with a PC5 QoS flow-1, a PC5 QoS flow-2, and a PC5 QoS flow-3, which arrive sequentially in terms of time. Based on an upper-layer configuration requirement of the SL UE, the PC5 QoS flow-1 is mapped to an SL freq-1 and an SL freq-2; the PC5 QoS flow-2 is mapped to the SL freq-1 and the SL freq-2; and the PC5 QoS flow-3 is mapped to an SL freq-3.

Each time a new PC5 QoS flow arrives, the UE needs to additionally determine an SL frequency associated with the new PC5 QoS flow, to determine whether to perform an SL-RB addition operation or modification operation. According to the foregoing example, if the PC5 QoS flow-1 arrives, an SL-RB addition operation is performed; if the PC5 QoS flow-2 arrives, because SL frequencies associated with the PC5 QoS flow-2 and the PC5 QoS flow-1 are the same, an SL-RB modification operation is performed on an SL-RB corresponding to the PC5 QoS flow 1; and if the PC5 QoS flow 3 arrives, because the SL frequency associated with the PC5 QoS flow 3 is different from the SL frequencies associated with the PC5 QoS flow-2 and the PC5 QoS flow-1, an SL-RB addition operation is performed.

Steps are executed as follows:

Step 2-0: A transmit end (UE 1) is in an RRC idle state or an RRC inactive state, and the UE 1 performs NR SL communication or NR SL discovery with peer UE (UE 2).

Step 2-1: The UE 1 receives a SIB message sent by a serving base station, where the SIB message includes at least one SL-RB related configuration, and each SL-RB configuration includes a mapping relationship between one SL-RB configuration index and at least one PC5 QoS flow.

Step 2-2: (For SL groupcast or broadcast): If one PC5 QoS flow at an upper layer of the UE 1 arrives at an AS of the UE 1, an SL-RB addition operation or an SL-RB modification operation is triggered.

Based on the SL-RB configuration in the SIB message, if it is determined that any of the following conditions is met, the UE 1 triggers an SL-RB addition operation:
(1) an SL-RB to which the PC5 QoS flow is mapped has not been established; and
(2) the SL-RB to which the PC5 QoS flow is mapped has been established, and an SL frequency to which the PC5 QoS flow is mapped is different from an SL frequency associated with the established SL-RB. The SL frequency associated with the established SL-RB is determined by an SL frequency to which at least one PC5 QoS flow established on the SL-RB is mapped.

Based on the SL-RB configuration in the SIB message, if it is determined that the following condition is met, the UE 1 triggers an SL-RB modification operation: the SL-RB to which the PC5 QoS flow is mapped has been established, and an SL frequency to which the PC5 QoS flow is mapped is the same as an SL frequency of the established SL-RB. The SL frequency associated with the established SL-RB is determined by an SL frequency to which at least one PC5 QoS flow established on the SL-RB is mapped.

In some embodiments, in the case of performing an SL-RB addition operation, if it is determined that the following condition is met, a duplication enable operation in the SL-RB configuration is ignored: there is only one SL frequency associated with a to-be-established SL-RB, and the SL frequency associated with the to-be-established SL-RB is determined by the SL frequency to which the PC5 QoS flow is mapped.

In some embodiments, in the case of performing an SL-RB modification operation, if it is determined that the following condition is met, a duplication enable operation in the SL-RB configuration is ignored: there is only one SL frequency associated with the SL-RB after the SL-RB modification operation is performed. The SL frequency associated with the SL-RB after the SL-RB modification operation is performed is jointly determined by an SL frequency to which a PC5 QoS flow on an SL-RB on which the SL-RB modification operation has not been performed is mapped and an SL frequency to which at least one PC5 QoS flow on the SL-RB when the SL-RB modification operation is performed is mapped.

Step 2-3: (For SL unicast): An operation of the UE 1 is the same as that in step 2-2. In addition, the UE 1 sends an RRCReconfigurationSidelink message to the UE 2, where the RRCReconfigurationSidelink message carries an SL-RB establishment or modification operation indication corresponding to the PC5 QoS flow.

An SL-RB addition operation indication corresponding to the PC5 QoS flow is carried when the following condition is met:
(1) an SL-RB to which the PC5 QoS flow is mapped has not been established; and
(2) the SL-RB to which the PC5 QoS flow is mapped has been established, and an SL frequency to which the PC5 QoS flow is mapped is different from an SL frequency associated with the established SL-RB. The SL frequency associated with the established SL-RB is determined by an SL frequency to which at least one PC5 QoS flow established on the SL-RB is mapped.

An SL-RB operation indication corresponding to the PC5 QoS flow is carried when the following condition is met:
the SL-RB to which the PC5 QoS flow is mapped has been established, and an SL frequency to which the PC5 QoS flow is mapped is the same as an SL frequency of the established SL-RB. The SL frequency associated with the established SL-RB is determined by an SL frequency to which at least one PC5 QoS flow established on the SL-RB is mapped.

### Embodiment 3: SL UE Out of Network Coverage

If a transmit end (UE 1) is out of network coverage, the SIB message in Embodiment 2 is replaced with a SidelinkPreconfigNR (SL preconfiguration) message, and other steps and content may be the same as those in Embodiment 2.

In this embodiment of this application, for SL UE in an RRC connected state, through SL UE assistance information reporting+base station configuration, it is ensured that “PC5 QoS flows with different SL frequencies are mapped to different SL-RB configurations”. For SL UE in an RRC_IDLE, RRC_INACTIVE or OOC state, an additional behavior specification on the SL UE side is introduced. In behavior of establishing an SL-RB, when PC5 QoS flows are mapped to different SL frequencies, an additional SL radio bearer is triggered to be established, to ensure that PC5 QoS flows with different SL frequencies are mapped to different SL-RB configurations. By adapting a frequency mapping rule at a granularity of a PC5 QoS flow level of an NR SL from both an SL-RB configuration on the network side and SL-RB establishment behavior on the UE side, normal operation of the NR SL CA mechanism is supported, to primarily safeguard against potential impact on Uu air interface radio bearer configuration and establishment procedures.

The SL configuration assistance method provided in the embodiments of this application may be executed by an SL configuration assistance apparatus. In the embodiments of this application, an example in which the SL configuration assistance apparatus executes the SL configuration assistance method is used to describe the SL configuration assistance apparatus provided in the embodiments of this application.

FIG. 14 is a first schematic structural diagram of an SL configuration assistance apparatus according to an embodiment of this application. As shown in FIG. 14, an SL configuration assistance apparatus 1400 includes:
a first sending module 1401, configured to send SL assistance information to a network side device, where the SL assistance information represents a mapping relationship between at least one PC5 QoS flow and at least one SL frequency, and the SL assistance information is used to assist in SL-RB configuration.

In this embodiment of this application, an SL configuration assistance apparatus applicable to an NR SL CA scenario is provided. For example, a first sending module of a first terminal sends SL assistance information to a network side device, where the SL assistance information represents a mapping relationship between at least one PC5 QoS flow and at least one SL frequency. Therefore, the network side device may assist in SL-RB configuration by using the mapping relationship represented by the SL assistance information, thereby adapting to a granularity of a PC5 QoS flow level of an NR SL. That is, a frequency mapping method at a PC5 QoS flow level is proposed, so that after SL-RB configuration is performed by using the mapping relationship, the first terminal can work based on a frequency specified by an upper layer protocol of the terminal to implement accurate configuration of an SL radio bearer in the NR SL CA scenario.

In some embodiments, the SL configuration assistance apparatus 1400 further includes:
a second processing module, configured to:
receive first radio bearer configuration information from the network side device; and
perform an operation of applying the first radio bearer configuration information, where the first radio bearer configuration information includes a mapping relationship between at least one SL-RB and at least one PC5 QoS flow, and SL frequencies of PC5 QoS flows associated with each SL-RB configuration are the same.

In some embodiments, the second processing module is further configured to:
receive first radio bearer configuration information from the network side device;
determine a determining result based on whether the first radio bearer configuration information meets a first condition; and
perform a corresponding target operation based on the determining result, where
the first condition includes: the first radio bearer configuration information includes a mapping relationship between at least one SL-RB and at least one PC5 QoS flow, and SL frequencies of PC5 QoS flows associated with each SL-RB configuration are the same.

In some embodiments, when the determining result is that the first radio bearer configuration information meets the first condition, the target operation may include: applying the first radio bearer configuration information; and
when the determining result is that the first radio bearer configuration information does not meet the first condition, the target operation may include at least one of the following operations:
(1) considering that the first radio bearer configuration information is invalid;
(2) considering that a radio resource control RRC reconfiguration procedure corresponding to the first radio bearer configuration information fails;
(3) triggering an RRC re-establishment procedure; and
(4) sending radio bearer-related configuration failure information to the network side device.

In some embodiments, the first sending module 1401 is configured to send the SL assistance information to the network side device when it is determined that the second condition is met, where
the second condition includes at least one of the following:
a. the network side device supports SL multi-carrier transmission;
b. the network side device supports an SL CA function;
c. the mapping relationship changes relative to the last SL assistance information sent by the first terminal; and
d. the at least one PC5 QoS flow is used for SL unicast communication.

In some embodiments, the second processing module is further configured to:
receive first configuration information from an upper layer of the first terminal, where the first configuration information includes the mapping relationship between the at least one PC5 QoS flow and the at least one SL frequency; and
determine the SL assistance information based on the first configuration information, where
the upper layer is a protocol layer above an access stratum of the first terminal.

In some embodiments, the SL assistance information may include any one of the following:
(1) a first mapping relationship among a Destination Layer-2 ID, at least one PC5 QoS flow identity, and at least one SL frequency; and
(2) a second mapping relationship between the at least one PC5 QoS flow identity and the at least one SL frequency.

In some embodiments, the first mapping relationship may meet any one of the following:
a. based on a first combination of the Destination Layer-2 ID and a part of the at least one PC5 QoS flow identity, at least one SL frequency corresponding to the first combination is determined; and
b. based on a second combination of the Destination Layer-2 ID and a part of the at least one SL frequency, at least one PC5 QoS flow identity corresponding to the second combination is determined.

In some embodiments, the second mapping relationship may meet any one of the following:
(a) based on a third combination of a part of the at least one PC5 QoS flow identity, at least one SL frequency corresponding to the third combination is determined; and
(b) based on a fourth combination of a part of the at least one SL frequency, at least one PC5 QoS flow identity corresponding to the fourth combination is determined.

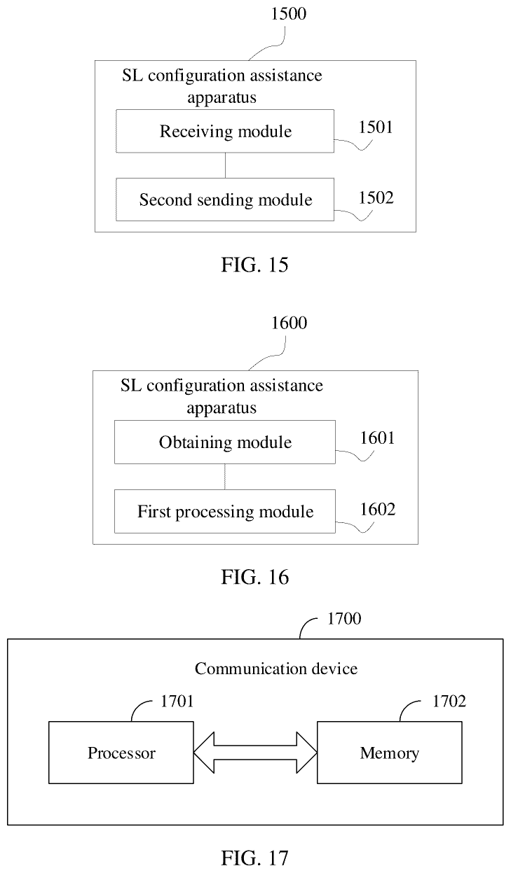

FIG. 15 is a second schematic structural diagram of an SL configuration assistance apparatus according to an embodiment of this application. As shown in FIG. 15, an SL configuration assistance apparatus 1500 includes:
a receiving module 1501, configured to receive SL assistance information from a first terminal, where the SL assistance information represents a mapping relationship between at least one PC5 quality of service flow QoS flow and at least one SL frequency; and
a second sending module 1502, configured to send first radio bearer configuration information to the first terminal, where the first radio bearer configuration information includes a mapping relationship between at least one SL radio bearer SL-RB and at least one PC5 QoS flow, and SL frequencies of PC5 QoS flows associated with each SL-RB configuration are the same.

In this embodiment of this application, an SL configuration assistance apparatus applicable to an NR SL CA scenario is provided. For example, a receiving module of a network side device receives SL assistance information from a first terminal, where the SL assistance information represents a mapping relationship between at least one PC5 QoS flow and at least one SL frequency. Therefore, a second sending module of the network side device may assist in SL-RB configuration based on the mapping relationship represented by the SL assistance information. For example, first radio bearer configuration information is sent to the first terminal, where the first radio bearer configuration information includes a mapping relationship between at least one SL-RB and at least one PC5 QoS flow, and SL frequencies of PC5 QoS flows associated with each SL-RB configuration are the same, to ensure that PC5 QoS flows with different SL frequencies are not mapped to a same SL-RB, thereby adapting to a granularity of a PC5 QoS flow level of an NR SL. That is, a frequency mapping method at a PC5 QoS flow level is proposed, so that after SL-RB configuration is performed by using the mapping relationship, the first terminal can work based on a frequency specified by an upper layer protocol of the terminal to implement accurate configuration of an SL radio bearer in the NR SL CA scenario.

In some embodiments, the SL assistance information may include any one of the following:
(1) a first mapping relationship among a Destination Layer-2 ID, at least one PC5 QoS flow identity, and at least one SL frequency; and
(2) a second mapping relationship between the at least one PC5 QoS flow identity and the at least one SL frequency.

In some embodiments, the first mapping relationship may meet any one of the following:
a. based on a first combination of the Destination Layer-2 ID and a part of the at least one PC5 QoS flow identity, at least one SL frequency corresponding to the first combination is determined; and
b. based on a second combination of the Destination Layer-2 ID and a part of the at least one SL frequency, at least one PC5 QoS flow identity corresponding to the second combination is determined.

In some embodiments, the second mapping relationship may meet any one of the following:
(a) based on a third combination of a part of the at least one PC5 QoS flow identity, at least one SL frequency corresponding to the third combination is determined; and
(b) based on a fourth combination of a part of the at least one SL frequency, at least one PC5 QoS flow identity corresponding to the fourth combination is determined.

In some embodiments, the second sending module 1502 is configured to:
determine the first radio bearer configuration information based on first information; and
send the first radio bearer configuration information to the first terminal, where
the first information includes at least one of the following:
(1) a QoS parameter requirement of the at least one PC5 QoS flow; and
(2) the mapping relationship represented by the SL assistance information.

FIG. 16 is a third schematic structural diagram of an SL configuration assistance apparatus according to an embodiment of this application. As shown in FIG. 16, an SL configuration assistance apparatus 1600 includes:
an obtaining module 1601, configured to obtain second radio bearer configuration information, where the second radio bearer configuration information includes a mapping relationship between at least one SL-RB and at least one PC5 QoS flow; and
a first processing module 1602, configured to perform an SL-RB configuration operation on a to-be-transmitted target QoS flow based on the second radio bearer configuration information and a mapping relationship between at least one PC5 QoS flow and at least one SL frequency.

In this embodiment of this application, an SL configuration assistance apparatus applicable to an NR SL CA scenario is provided. For example, an obtaining module of a first terminal obtains second radio bearer configuration information, where the second radio bearer configuration information includes a mapping relationship between at least one SL-RB and at least one PC5 QoS flow. Therefore, a first processing module of the first terminal may perform an SL-RB configuration operation on a to-be-transmitted target QoS flow based on the second radio bearer configuration information and a mapping relationship between at least one PC5 QoS flow and at least one SL frequency, thereby adapting to a granularity of a PC5 QoS flow level of an NR SL. That is, a frequency mapping method at a PC5 QoS flow level is proposed, so that after the SL-RB configuration operation is performed on the to-be-transmitted target QoS flow by using the mapping relationship, the first terminal can work based on a frequency specified by an upper layer protocol of the terminal to implement accurate configuration of an SL radio bearer in the NR SL CA scenario.

In some embodiments, the first processing module 1602 is configured to perform an SL-RB addition operation when determining, based on the second radio bearer configuration information and the mapping relationship between the at least one PC5 QoS flow and the at least one SL frequency, that the target QoS flow meets a third condition, where
the third condition includes any one of the following:
(1) an SL-RB to which the target QoS flow is mapped has not been established; and
(2) the SL-RB to which the target QoS flow is mapped has been established, and an SL frequency set to which the target QoS flow is mapped is different from an SL frequency set to which the established target SL-RB is mapped.

In some embodiments, the first processing module 1602 is further configured to send a first message to a second terminal when the target QoS flow meets the third condition, where the first message carries first indication information used to instruct to perform an SL-RB addition operation, where the first terminal communicates with the second terminal through SL unicast.

In some embodiments, the first processing module 1602 is further configured to perform an SL-RB modification operation when determining, based on the second radio bearer configuration information and the mapping relationship between the at least one PC5 QoS flow and the at least one SL frequency, that the target QoS flow meets a fourth condition, where
the fourth condition includes: an SL-RB to which the target QoS flow is mapped has been established, and an SL frequency set to which the target QoS flow is mapped is the same as an SL frequency set to which the established target SL-RB is mapped.

In some embodiments, the first processing module 1602 is further configured to send a second message to a second terminal when the target QoS flow meets the fourth condition, where the second message carries second indication information used to instruct to perform an SL-RB modification operation, where
the first terminal communicates with the second terminal through SL unicast.

In some embodiments, the first processing module 1602 is further configured to receive second configuration information from an upper layer of the first terminal, where
the upper layer is a protocol layer above an access stratum of the first terminal, and the second configuration information includes at least one of the following:
a. the mapping relationship between the at least one PC5 QoS flow and the at least one SL frequency; and
b. the to-be-transmitted target QoS flow.

In some embodiments, the obtaining module 1601 is configured to:
receive a system information block SIB message from a network side device when the first terminal is in a radio resource control RRC idle state or an RRC inactive state, where the SIB message includes the second radio bearer configuration information; and
obtain the second radio bearer configuration information through an SL preconfiguration message when the first terminal is out of network coverage.

In some embodiments, the second radio bearer configuration information further includes packet data convergence protocol PDCP duplication enable configuration information corresponding to a part or all of the at least one SL-RB; and

the first processing module 1602 is further configured to:
when it is determined to perform an SL-RB addition operation, if a quantity of SL frequencies associated with a to-be-established first SL-RB is less than a first preset threshold, ignore PDCP duplication enable configuration information corresponding to the first SL-RB; and
when it is determined to perform an SL-RB modification operation, if a quantity of SL frequencies associated with a second SL-RB after the SL-RB modification operation is performed is less than a second preset threshold, ignore, by the first terminal, PDCP duplication enable configuration information corresponding to the second SL-RB.

The SL configuration assistance apparatus in this embodiment of this application may be an electronic device, for example, an electronic device with an operating system, or may be a component in the electronic device, for example, an integrated circuit or a chip. The electronic device may be a terminal, or another device other than the terminal. For example, the terminal may include but is not limited to the foregoing listed type of the terminal 11. The another device may be a server, a Network Attached Storage (NAS), or the like. This is not specifically limited in this embodiment of this application.

The SL configuration assistance apparatus provided in this embodiment of this application can implement the processes implemented in the method embodiments of FIG. 10 to FIG. 13, and achieve a same technical effect. To avoid repetition, details are not described herein again.

FIG. 17 is a schematic structural diagram of a communication device according to an embodiment of this application. As shown in FIG. 17, an embodiment of this application further provides a communication device 1700, including a processor 1701 and a memory 1702. The memory 1702 stores a program or an instruction that can be run on the processor 1701. For example, when the communication device 1700 is a first terminal, the program or the instruction is executed by the processor 1701 to implement the steps of the foregoing SL configuration assistance method embodiment on the first terminal side, and a same technical effect can be achieved. When the communication device 1700 is a network side device, the program or the instruction is executed by the processor 1701 to implement the steps of the foregoing SL configuration assistance method embodiment on the network side, and a same technical effect can be achieved. To avoid repetition, details are not described herein again.

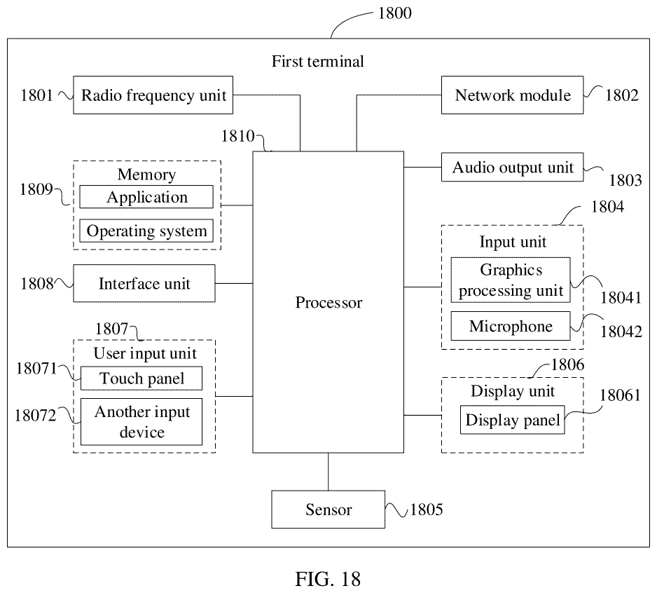

An embodiment of this application further provides a first terminal, including a processor and a communication interface. The communication interface is coupled to the processor, and the processor is configured to run a program or an instruction to implement the steps of the method embodiment shown in FIG. 10 or FIG. 12. This first terminal embodiment corresponds to the foregoing method embodiment on the first terminal side. Each implementation process and implementation of the foregoing method embodiment may be applicable to this first terminal embodiment, and a same technical effect can be achieved. For example, FIG. 18 is a schematic structural diagram of hardware of a first terminal according to an embodiment of this application.

The first terminal 1800 includes but is not limited to a part of components such as a radio frequency unit 1801, a network module 1802, an audio output unit 1803, an input unit 1804, a sensor 1805, a display unit 1806, a user input unit 1807, an interface unit 1808, a memory 1809, and a processor 1810.

A person skilled in the art can understand that the first terminal 1800 may further include the power supply (for example, a battery) that supplies power to each component. The power supply may be logically connected to the processor 1810 by using a power supply management system, so as to manage functions such as charging, discharging, and power consumption by using the power supply management system. The terminal structure shown in FIG. 18 constitutes no limitation on the first terminal, and the first terminal may include more or fewer components than those shown in the figure, or combine some components, or have different component arrangements. Details are not described herein.

It should be understood that, in this embodiment of this application, the input unit 1804 may include a Graphics Processing Unit (GPU) 18041 and a microphone 18042, and the graphics processing unit 18041 processes image data of a still image or a video that is obtained by an image capturing apparatus (for example, a camera) in a video capturing mode or an image capturing mode. The display unit 1806 may include a display panel 18061. The display panel 18061 may be configured in a form such as a liquid crystal display or an organic light-emitting diode. The user input unit 1807 includes at least one of a touch panel 18071 and another input device 18072. The touch panel 18071 is also referred to as a touchscreen. The touch panel 18071 may include two parts: a touch detection apparatus and a touch controller. The another input device 18072 may include but is not limited to a physical keyboard, a functional button (such as a volume control button or a power on/off button), a trackball, a mouse, and a joystick. Details are not described herein.

In this embodiment of this application, after receiving downlink data from a network side device, the radio frequency unit 1801 may transmit the downlink data to the processor 1810 for processing. In addition, the radio frequency unit 1801 may send uplink data to the network side device. Usually, the radio frequency unit 1801 includes but is not limited to an antenna, an amplifier, a transceiver, a coupler, a low noise amplifier, a duplexer, and the like.

The memory 1809 may be configured to store a software program or an instruction and various data. The memory 1809 may mainly include a first storage area for storing a program or an instruction and a second storage area for storing data. The first storage area may store an operating system, and an application or an instruction required by at least one function (for example, a sound playing function or an image playing function). In addition, the memory 1809 may include a volatile memory or a non-volatile memory. The nonvolatile memory may be a Read-Only Memory (ROM), a Programmable ROM (PROM), an Erasable PROM (EPROM), an Electrically EPROM (EEPROM), or a flash memory. The volatile memory may be a Random Access Memory (RAM), a Static RAM (SRAM), a Dynamic RAM (DRAM), a Synchronous DRAM (SDRAM), a Double Data Rate SDRAM (DDRSDRAM), an Enhanced SDRAM (ESDRAM), a Synch Link DRAM (SLDRAM), and a Direct Rambus RAM (DRRAM). The memory 1809 in this embodiment of this application includes but is not limited to these memories and a memory of any other proper type.

The processor 1810 may include one or more processing units. In some embodiments, an application processor and a modem processor are integrated into the processor 1810. The application processor mainly processes an operating system, a user interface, an application, and the like. The modem processor mainly processes a wireless communication signal, for example, a baseband processor. It can be understood that, in an alternative embodiment, the modem processor may not be integrated into the processor 1810.

It can be understood that, for an implementation process of the implementations mentioned in this embodiment, reference may be made to related descriptions of the foregoing method embodiment on the first terminal side, and a same or corresponding technical effect is achieved. To avoid repetition, details are not described herein again.

An embodiment of this application further provides a network side device, including a processor and a communication interface. The communication interface is coupled to the processor, and the processor is configured to run a program or an instruction to implement the steps of the method embodiment shown in FIG. 11. This network side device embodiment corresponds to the foregoing method embodiment on the network side device. Each implementation process and implementation of the foregoing method embodiment may be applicable to this network side device embodiment, and a same technical effect can be achieved.

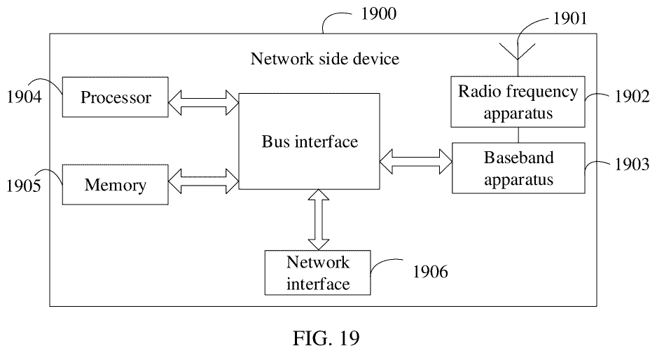

For example, an embodiment of this application further provides a network side device. FIG. 19 is a schematic structural diagram of a network side device according to an embodiment of this application. As shown in FIG. 19, the network side device 1900 includes an antenna 1901, a radio frequency apparatus 1902, a baseband apparatus 1903, a processor 1904, and a memory 1905. The antenna 1901 is connected to the radio frequency apparatus 1902. In an uplink direction, the radio frequency apparatus 1902 receives information by using the antenna 1901, and sends the received information to the baseband apparatus 1903 for processing. In a downlink direction, the baseband apparatus 1903 processes information that needs to be sent, and sends processed information to the radio frequency apparatus 1902. The radio frequency apparatus 1902 processes the received information, and sends processed information by using the antenna 1901.

In the foregoing embodiment, the method executed by the network side device may be implemented in the baseband apparatus 1903. The baseband apparatus 1903 includes a baseband processor.

The baseband apparatus 1903 may include, for example, at least one baseband board, where a plurality of chips are disposed on the baseband board. As shown in FIG. 19, one chip is, for example, the baseband processor, is connected to the memory 1905 through a bus interface, to invoke a program in the memory 1905 to perform the operations of the network device shown in the foregoing method embodiment.

The network side device may further include a network interface 1906, and the interface is, for example, a Common Public Radio Interface (CPRI).

For example, the network side device 1900 in this embodiment of this application further includes an instruction or a program that is stored in the memory 1905 and that can be run on the processor 1904. The processor 1904 invokes the instruction or the program in the memory 1905 to execute the method executed by the modules shown in FIG. 15, and a same technical effect is achieved. To avoid repetition, details are not described herein again.

An embodiment of this application further provides a readable storage medium. The readable storage medium stores a program or an instruction, and the program or the instruction is executed by a processor to implement the processes of the foregoing SL configuration assistance method embodiment, and a same technical effect can be achieved. To avoid repetition, details are not described herein again.

The processor is a processor in the terminal in the foregoing embodiment. The readable storage medium includes a computer readable storage medium, such as a computer read-only memory ROM, a random access memory RAM, a magnetic disk, or an optical disc. In some examples, the readable storage medium may be a non-transient readable storage medium.

An embodiment of this application further provides a chip. The chip includes a processor and a communication interface, the communication interface is coupled to the processor, and the processor is configured to run a program or an instruction to implement the processes of the foregoing SL configuration assistance method embodiment, and a same technical effect can be achieved. To avoid repetition, details are not described herein again.

It should be understood that the chip mentioned in this embodiment of this application may also be referred to as a system-level chip, a system chip, a chip system, or an on-chip system chip.

An embodiment of this application further provides a computer program/program product. The computer program/program product is stored in a storage medium, and the program/program product is executed by at least one processor to implement the processes of the foregoing SL configuration assistance method embodiment, and a same technical effect can be achieved. To avoid repetition, details are not described herein again.

An embodiment of this application further provides an SL configuration assistance system, including a first terminal and a network side device. The first terminal may be configured to perform the steps of the foregoing SL configuration assistance method on the first terminal side, and the network side device may be configured to perform the steps of the foregoing SL configuration assistance method on the network side.

It should be noted that, in this specification, the terms “include”, “comprise”, or their any other variant are intended to cover a non-exclusive inclusion, so that a process, a method, an article, or an apparatus that includes a list of elements not only includes those elements but also includes other elements which are not expressly listed, or further includes elements inherent to such process, method, article, or apparatus. An element preceded by “includes a . . . ” does not, without more constraints, preclude the presence of additional identical elements in the process, method, article, or apparatus that includes the element. In addition, it should be noted that the scope of the method and the apparatus in the embodiments of this application is not limited to performing functions in an illustrated or discussed sequence, and may further include performing functions in a basically simultaneous manner or in a reverse sequence according to the functions concerned. For example, the described method may be performed in an order different from that described, and the steps may be added, omitted, or combined. In addition, features described with reference to some examples may be combined in other examples.

Based on the foregoing descriptions of the embodiments, a person skilled in the art may clearly understand that the foregoing method embodiment may be implemented by computer software product in addition to a necessary general hardware platform or by hardware. The computer software product is stored in a storage medium (for example, a ROM, a RAM, a magnetic disk, or an optical disc) and includes several instructions, so that the terminal or the network side device executes the methods described in the embodiments of this application.

The embodiments of this application are described above with reference to the accompanying drawings, but this application is not limited to the above implementations, and the above implementations are merely illustrative but not restrictive. Under the enlightenment of this application, a person of ordinary skill in the art can make many forms of implementations without departing from the purpose of this application and the protection scope of the claims, all of which fall within the protection of this application.

1. A Sidelink (SL) configuration assistance method, comprising:
sending, by a first terminal, SL assistance information to a network side device, wherein the SL assistance information represents a mapping relationship between at least one PC5 Quality Of Service (QoS) flow and at least one SL frequency, and the SL assistance information is used to assist in SL-Radio Bearer (RB) configuration.

2. The SL configuration assistance method according to claim 1, further comprising:
receiving, by the first terminal, first radio bearer configuration information from the network side device; and
performing, by the first terminal, an operation of applying the first radio bearer configuration information, wherein the first radio bearer configuration information comprises a mapping relationship between at least one SL-RB and at least one PC5 QoS flow, and SL frequencies of PC5 QoS flows associated with each SL-RB configuration are the same.

3. The SL configuration assistance method according to claim 1, further comprising:
receiving, by the first terminal, first radio bearer configuration information from the network side device;
determining, by the first terminal, a determining result based on whether the first radio bearer configuration information meets a first condition; and
performing, by the first terminal, a corresponding target operation based on the determining result, wherein
the first condition comprises: the first radio bearer configuration information comprises a mapping relationship between at least one SL-RB and at least one PC5 QoS flow, and SL frequencies of PC5 QoS flows associated with each SL-RB configuration are the same.

4. The SL configuration assistance method according to claim 3, wherein when the determining result is that the first radio bearer configuration information meets the first condition, the target operation comprises: applying the first radio bearer configuration information; and
when the determining result is that the first radio bearer configuration information does not meet the first condition, the target operation comprises at least one of the following operations:
considering that the first radio bearer configuration information is invalid;
considering that a Radio Resource Control (RRC) reconfiguration procedure corresponding to the first radio bearer configuration information fails;
triggering an RRC re-establishment procedure; or
sending radio bearer-related configuration failure information to the network side device.

5. The SL configuration assistance method according to claim 1, wherein the sending, by a first terminal, SL assistance information to a network side device comprises:
sending, by the first terminal, the SL assistance information to the network side device when it is determined that a second condition is met,
wherein:
the second condition comprises at least one of the following:
the network side device supports SL multi-carrier transmission; or
the network side device supports an SL carrier aggregation CA function.

6. The SL configuration assistance method according to claim 1, further comprising:
receiving, by the first terminal, first configuration information from an upper layer of the first terminal, wherein the first configuration information comprises the mapping relationship between the at least one PC5 QoS flow and the at least one SL frequency; and
determining, by the first terminal, the SL assistance information based on the first configuration information, wherein
the upper layer is a protocol layer above an access stratum of the first terminal.

7. The SL configuration assistance method according to claim 1, wherein the SL assistance information comprises:
a first mapping relationship among a Destination Layer-2 Identity (ID), at least one PC5 QoS flow identity, and at least one SL frequency.

8. The SL configuration assistance method according to claim 7, wherein the first mapping relationship meets:
based on a first combination of the Destination Layer-2 ID and a part of the at least one PC5 QoS flow identity, at least one SL frequency corresponding to the first combination is determined.

9. A first terminal, comprising: a processor; and a memory, wherein the memory stores a program or an instruction that can be run on the processor, and the program or the instruction, when executed by the processor, causes the processor to perform operations comprising:
sending Sidelink (SL) assistance information to a network side device, wherein the SL assistance information represents a mapping relationship between at least one PC5 Quality Of Service (QoS) flow and at least one SL frequency, and the SL assistance information is used to assist in SL-Radio Bearer (RB) configuration.

10. The first terminal according to claim 9, wherein the operations further comprise:
receiving first radio bearer configuration information from the network side device;
determining a determining result based on whether the first radio bearer configuration information meets a first condition; and
performing a corresponding target operation based on the determining result,
wherein the first condition comprises:
the first radio bearer configuration information comprises a mapping relationship between at least one SL-RB and at least one PC5 QoS flow, and SL frequencies of PC5 QoS flows associated with each SL-RB configuration are the same.

11. The first terminal according to claim 10, wherein
when the determining result is that the first radio bearer configuration information meets the first condition, the target operation comprises: applying the first radio bearer configuration information; and
when the determining result is that the first radio bearer configuration information does not meet the first condition, the target operation comprises at least one of the following operations:
considering that the first radio bearer configuration information is invalid,
considering that a Radio Resource Control (RRC) reconfiguration procedure corresponding to the first radio bearer configuration information fails,
triggering an RRC re-establishment procedure, or
sending radio bearer-related configuration failure information to the network side device.

12. The first terminal according to claim 9, wherein sending the SL assistance information to the network side device comprises:
sending the SL assistance information to the network side device when it is determined that a second condition is met,
wherein:
the second condition comprises at least one of the following:
the network side device supports SL multi-carrier transmission; or
the network side device supports an SL carrier aggregation CA function.

13. The first terminal according to claim 9, wherein the operations further comprise:
receiving first configuration information from an upper layer of the first terminal, wherein the first configuration information comprises the mapping relationship between the at least one PC5 QoS flow and the at least one SL frequency; and
determining the SL assistance information based on the first configuration information, wherein the upper layer is a protocol layer above an access stratum of the first terminal.

14. The first terminal according to claim 9, wherein the SL assistance information comprises:
a first mapping relationship among a Destination Layer-2 Identity (ID), at least one PC5 QoS flow identity, and at least one SL frequency.

15. The first terminal according to claim 14, wherein the first mapping relationship meets:
based on a first combination of the Destination Layer-2 ID and a part of the at least one PC5 QoS flow identity, at least one SL frequency corresponding to the first combination is determined.

16. A non-transitory computer-readable storage medium storing a program or an instruction that, when executed by a processor, causes the processor to perform operations comprising:
sending Sidelink (SL) assistance information to a network side device, wherein the SL assistance information represents a mapping relationship between at least one PC5 Quality Of Service (QoS) flow and at least one SL frequency, and the SL assistance information is used to assist in SL-Radio Bearer (RB) configuration.

17. The non-transitory computer-readable storage medium according to claim 16, wherein sending the SL assistance information to the network side device comprises:
sending the SL assistance information to the network side device when it is determined that a second condition is met,
wherein:
the second condition comprises at least one of the following:
the network side device supports SL multi-carrier transmission; or
the network side device supports an SL carrier aggregation CA function.

18. The non-transitory computer-readable storage medium according to claim 16, wherein the operations further comprise:
receiving first configuration information from an upper layer, wherein the first configuration information comprises the mapping relationship between the at least one PC5 QoS flow and the at least one SL frequency; and
determining the SL assistance information based on the first configuration information, wherein
the upper layer is a protocol layer above an access stratum of the processor.

19. The non-transitory computer-readable storage medium according to claim 16, wherein the SL assistance information comprises:
a first mapping relationship among a Destination Layer-2 Identity (ID), at least one PC5 QoS flow identity, and at least one SL frequency.

20. The non-transitory computer-readable storage medium according to claim 19, wherein the first mapping relationship meets:
based on a first combination of the Destination Layer-2 ID and a part of the at least one PC5 QoS flow identity, at least one SL frequency corresponding to the first combination is determined.
